(19) United States
(12) Patent Application Publication
(10) Pub. No.: US 2026/0141302 A1
(43) Pub. Date: May 21, 2026

(54) SYSTEM AND METHOD FOR INTELLIGENT ACTION SUGGESTION

(71) Applicant: Twos Technologies Incorporated, Tampa, FL (US)

(72) Inventors: Parker Allen Klein, Tampa, FL (US); Joseph Augustus Steilberg, Tampa, FL (US)

(21) Appl. No.: 19/375,090

(22) Filed: Oct. 30, 2025

Related U.S. Application Data
(60) Provisional application No. 63/722,335, filed on Nov. 19, 2024.

(51) Int. Cl. G06N 20/00

(52) U.S. Cl. CPC G06N 20/00

(57) ABSTRACT

A method may comprise receiving user input from a user device and categorizing the input into at least one category using artificial intelligence processing. At least one smart suggestion may be generated based on the user input and the at least one category. The at least one smart suggestion may be transmitted to the user device for display. A user selection of the at least one smart suggestion may be received. A link to an external resource associated with the at least one smart suggestion may be provided in response to the user selection. The categorizing may comprise transmitting the user input to an artificial intelligence model and analyzing semantic content using natural language processing. The generating may comprise creating a prompt based on the at least one category and sending the prompt to an artificial intelligence model. The link may comprise an affiliate link configured to track user interactions.

### RELATED APPLICATION

Under provisions of 35 U.S.C. § 119(e), the Applicant claims benefit of U.S. Provisional Application No. 63/722,335 filed on Nov. 19, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to artificial intelligence-powered information processing and suggestion systems. More specifically, the disclosure relates to automated content analysis platforms that utilize machine learning algorithms to categorize user input and generate contextually relevant actionable suggestions with integrated resource linking capabilities.

### BACKGROUND

In some situations, users capture information across multiple platforms but struggle to convert this information into actionable steps. For example, a user might save a restaurant recommendation in a note-taking application, bookmark a product on a shopping website, or receive a book suggestion through a messaging platform, but these captured items remain isolated and require manual effort to act upon. Thus, the conventional strategy is to maintain separate applications for information capture, organization, and task execution. This often causes problems because the conventional strategy does not provide automated connections between captured information and relevant action platforms. For example, users must manually search for restaurants on booking platforms, navigate to e-commerce sites to purchase recommended products, or remember to add suggested books to their reading lists.

Conventional productivity systems typically function as passive information repositories. Note-taking applications store text and media without analyzing content for actionable insights. Task management platforms require manual entry of specific action items. Digital assistants respond to explicit queries but do not proactively process user-generated content. E-commerce platforms operate independently from information capture systems. Streaming services lack integration with recommendation sources. Calendar applications require manual event creation from captured information.

Traditional artificial intelligence implementations in consumer applications operate through conversational interfaces that interrupt natural workflows. Users must formulate specific prompts to receive assistance. AI systems typically require direct interaction rather than autonomous processing of background information. Current implementations lack contextual understanding of diverse information types captured across different platforms.

Information fragmentation presents significant challenges across multiple technical domains. Users frequently encounter difficulties when attempting to consolidate diverse data types from various sources into coherent, actionable workflows. Content categorization systems lack automated intelligence to distinguish between different types of actionable information. Manual processing requirements create substantial cognitive overhead for users attempting to transform captured information into executable tasks.

Cross-platform integration limitations prevent seamless data flow between information capture systems and action execution platforms. Users experience workflow disruption when transitioning between applications to complete related tasks. Application context switching results in productivity losses and increased task completion times. Information silos prevent effective utilization of captured data across different service platforms.

Artificial intelligence implementations in consumer applications typically operate through explicit interaction models. Users must formulate specific queries to receive AI assistance. Current AI systems lack autonomous processing capabilities for background information analysis. Contextual understanding remains limited across diverse information types and formats. Proactive suggestion generation requires manual user initiation rather than automatic content analysis.

E-commerce integration presents technical challenges for productivity applications. Users must manually navigate to shopping platforms after identifying products of interest. Service discovery requires separate searches across multiple platforms. Affiliate marketing systems operate independently from information capture workflows. Revenue generation mechanisms lack integration with productivity-focused applications.

Cross-device synchronization creates consistency challenges for information management systems. Data persistence across multiple platforms requires complex technical implementations. User experience uniformity becomes difficult to maintain across different device types and operating systems. Platform-specific limitations restrict functionality availability across different environments.

The need for such a solution arises because existing productivity systems create substantial inefficiencies when users attempt to transform captured information into executable actions across multiple platforms. Users frequently experience workflow disruption when transitioning between information capture applications and action execution platforms, resulting in lost context, increased cognitive overhead, and significant time delays between information acquisition and task completion. Current artificial intelligence implementations require explicit user interaction rather than autonomous processing of background information, while cross-platform integration limitations prevent seamless data flow between capture systems and relevant service platforms. These technical limitations force users to manually process diverse information types, perform separate searches across multiple platforms, and navigate complex application switching workflows to complete related tasks. Existing systems such as digital assistants or productivity tools perform independent, prompt-based operations and lack unified object-level data structures. The present disclosure provides a single, list-based environment where each captured element (“thing”) is processed as an actionable data object connected to both local and external actions.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A method may comprise receiving user input from a user device. The method may comprise categorizing the user input into at least one category using artificial intelligence processing. The method may comprise generating at least one smart suggestion based on the user input and the at least one category. The method may comprise transmitting the at least one smart suggestion to the user device for display. The method may comprise receiving a user selection of the at least one smart suggestion. The method may comprise providing a link to an external resource associated with the at least one smart suggestion in response to the user selection.

In some embodiments, the system improves computer functionality by converting unstructured user input into structured “atomic objects” that can be stored, indexed, and executed as discrete data elements, thereby reducing processing latency and eliminating repetitive parsing operations common to conventional note-taking systems.

The disclosed system implements dedicated processors, memory resources, and communication interfaces configured to operate artificial intelligence models for context classification and action suggestion generation. These technical components execute machine-learned algorithms in real-time to enable transformation of unstructured data into structured categories, resulting in an improvement in computational efficiency, user data synchronization, and actionable output delivery. By architecting system modules that perform content analysis, real-time device synchronization, and secure external integration, the platform provides technical solutions to technical problems associated with fragmented manual workflows in conventional computing environments.

A system may comprise a memory storing instructions and a processor configured to execute the instructions. The processor may be configured to receive user input from a user device. The processor may be configured to categorize the user input into at least one category using artificial intelligence processing. The processor may be configured to generate at least one smart suggestion based on the user input and the at least one category. The processor may be configured to transmit the at least one smart suggestion to the user device for display. The processor may be configured to receive a user selection of the at least one smart suggestion. The processor may be configured to provide a link to an external resource associated with the at least one smart suggestion in response to the user selection.

A computing device may comprise a user interface configured to receive user input and display smart suggestions. The computing device may comprise a categorization module configured to analyze the user input and determine at least one category using artificial intelligence processing. The computing device may comprise a suggestion module configured to generate at least one smart suggestion based on the user input and the at least one category. The computing device may comprise a suggestion processing module configured to format the at least one smart suggestion for display and integrate affiliate codes into links. The computing device may comprise a communication interface configured to facilitate interaction with external resources.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a smart suggestion platform;

FIG. 3 is a block diagram of a system including a computing device for performing the method of FIG. 2;

FIG. 4A illustrates an example list integrating smart suggestion links;

FIG. 4B shows smart suggestions associated with a user input for a physical item;

FIG. 4C shows smart suggestions associated with a user input for a grocery item;

FIG. 4D shows smart suggestions associated with a user input for a food item;

FIG. 4E shows smart suggestions associated with a user input for a music content item;

FIG. 4F shows smart suggestions associated with a user input for a movie content item;

FIG. 4G shows smart suggestions associated with a user input for an event;

FIG. 4H shows smart suggestions associated with a user input for a hotel;

FIG. 4I shows smart suggestions associated with a user input for a restaurant;

FIG. 5 shows smart suggestions adding to a list based on past entries;

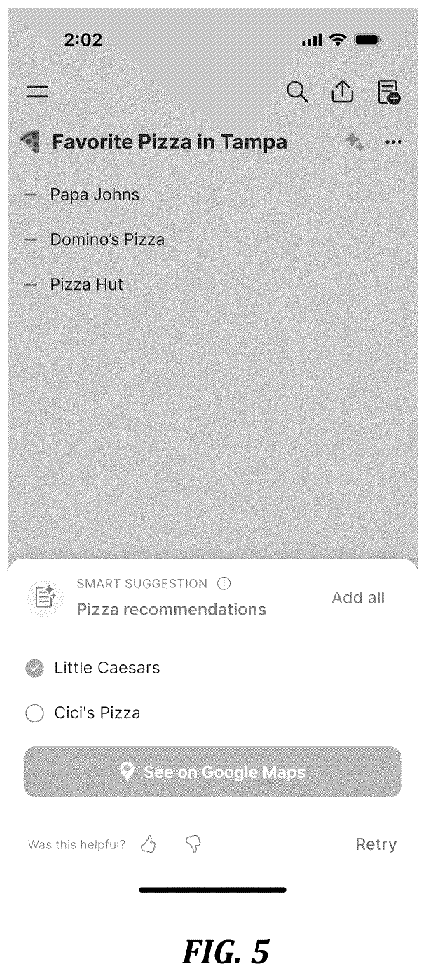

FIG. 6 shows smart suggestions for aggregating multiple list entries into a single suggestion;

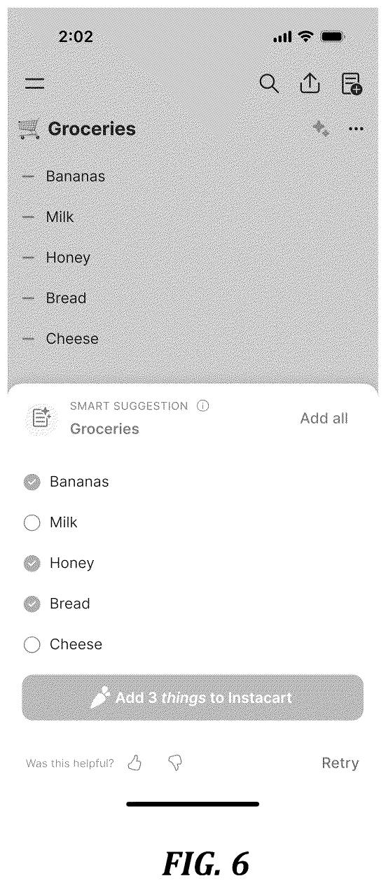

FIG. 7A shows smart suggestions for creating a new contact;

FIG. 7B shows smart suggestions for creating a reminder or a calendar event;

FIG. 7C shows smart suggestions for creating a to-do list item; and

FIG. 7D shows smart suggestions for creating a recurring calendar entry, creating a text message, and adding a reminder.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

The described system may be deployed as a mobile application (iOS, Android), a desktop client (Windows, macOS, Linux), or a browser-based web application, with the underlying architecture supporting cross-platform synchronization and device-agnostic operation. User input may be entered via virtual keyboard, physical keyboard, touchscreen, voice command, mouse pointer, or gesture-based interfaces depending on device capabilities. In some embodiments, the system may be integrated as a browser extension or plug-in, providing contextual smart suggestions within third-party websites and productivity applications. Voice-enabled versions may employ speech-to-text processing with similar categorization and suggestion algorithms.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

In certain embodiments, the system exposes a set of public and private application programming interfaces (APIs) that may be used by third-party developers to add new categories, customize smart suggestion templates, or integrate external databases and services. For example, partner organizations may register webhooks or callbacks with the platform to provide custom actions in response to identified user intents, such as booking appointments or obtaining external data. The system architecture may be modular, facilitating the addition of plug-in components for new use-cases and data sources without requiring modification of the core codebase.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Contemporary productivity applications present multiple technical challenges that limit user efficiency and task completion. Users may encounter fragmented workflows when attempting to transform captured information into actionable tasks. For example, a user may create a shopping list in a note-taking application but may need to manually transfer each item to separate e-commerce platforms to make purchases. This fragmentation may result in incomplete task execution and reduced productivity.

Traditional information management systems may operate as passive repositories that store user-generated content without providing contextual assistance. Users may need to perform manual searches across multiple platforms to locate relevant resources or services related to their captured information. The process of switching between applications may interrupt cognitive flow and may introduce friction that discourages task completion.

Existing artificial intelligence assistants may require explicit user queries to provide useful suggestions. These systems may not seamlessly integrate with natural information capture workflows. Users may need to actively engage with AI interfaces through specific commands or prompts, which may create additional cognitive overhead and may disrupt the spontaneous nature of information recording.

The technical problem extends to scenarios involving diverse information types within a single capture session. A user may record items spanning multiple categories such as grocery items, entertainment preferences, travel plans, and professional tasks within a single list or document. Conventional systems may not automatically recognize these diverse content types or may not provide category-specific actionable suggestions. This limitation may force users to manually organize and process different types of information using separate tools and platforms.

Cross-platform synchronization presents another technical challenge in existing productivity solutions. Users may capture information on one device but may need to access related actions or resources from another device. Traditional systems may not maintain consistent suggestion availability across multiple user devices, which may limit the utility of captured information when users switch between mobile, desktop, and web platforms.

Revenue generation through intelligent content analysis represents a technical problem that existing productivity platforms may not address effectively. While users may benefit from contextual suggestions, platform operators may lack mechanisms to monetize the value provided through intelligent content processing and suggestion generation.

The solution may address contemporary productivity challenges through an intelligent action suggestion system that transforms passive information capture into active task facilitation. The system may receive user input from various sources and may automatically analyze the semantic content to determine contextual categories. Based on the categorization results, the system may generate smart suggestions that connect users directly to relevant external resources or internal device functions.

The solution may operate across multiple computing platforms including mobile applications, web browsers, and desktop environments. Users may input information through text entry, voice commands, or integration with third-party services such as virtual assistants and messaging platforms. The system may process this information without requiring explicit user interaction with artificial intelligence interfaces, thereby maintaining workflow continuity while providing contextual assistance.

The categorization process may utilize natural language processing techniques to analyze user input and assign appropriate categories from a comprehensive taxonomy. Categories may include products, books, authors, groceries, locations, restaurants, foods, music albums, artists, songs, movies, actors, television shows, concerts, events, sports, videos, electronics, birthdays, anniversaries, contacts, flights, hotels, rental cars, home services, professional services, freelance work, and employment opportunities. The system may assign multiple categories to a single input when contextually appropriate and may generate confidence scores for each category assignment.

Smart suggestion generation may occur through artificial intelligence processing that considers both the determined categories and additional contextual factors. The system may send structured prompts to machine learning models that incorporate the categorized input, user location data, temporal information, and historical usage patterns. The artificial intelligence models may respond with contextually relevant suggestions that connect to both external platforms and internal device capabilities.

External resource integration may encompass e-commerce platforms for product purchases, streaming services for media content, booking systems for travel arrangements, social media platforms for content sharing, job search platforms for employment opportunities, and professional service platforms for specialized assistance. The system may maintain real-time connections with these external platforms through application programming interfaces to ensure suggestion accuracy and availability.

Internal function suggestions may include creating calendar events for time-sensitive items, setting reminders for future tasks, adding contacts for recognized personal information, composing text messages or emails for communication needs, and generating to-do list items for actionable tasks. These internal suggestions may leverage existing device capabilities and user data stores to provide seamless integration with personal productivity workflows.

The system may implement affiliate link integration to generate revenue while providing value to users. When suggestions include external commerce platforms, the system may embed tracking codes that attribute transactions to the suggestion platform. This revenue model may support continued development and platform maintenance while ensuring users receive relevant and useful suggestions without additional cost.

Cross-platform synchronization may enable users to access their input data and generated suggestions from multiple devices associated with their user account. The system may maintain consistent suggestion availability whether users access the platform through mobile applications, web interfaces, or desktop clients. Synchronization may occur in real-time to ensure users can seamlessly transition between devices while maintaining access to their information and suggestions.

Analytics and learning capabilities may enhance suggestion quality over time through user interaction tracking and feedback analysis. The system may monitor which suggestions users select, how frequently different types of suggestions generate engagement, and patterns in user behavior across various content categories. This data may inform machine learning model improvements and suggestion algorithm refinements to increase relevance and utility.

The solution may also support collaborative scenarios where multiple users contribute to shared lists or information repositories. The system may analyze shared content using the same categorization and suggestion generation processes, enabling team productivity enhancement and collaborative task completion. Suggestions generated from shared content may be accessible to all authorized collaborators while maintaining appropriate privacy controls.

Contextual awareness may extend beyond simple content analysis to include temporal factors, geographic location, and user preference patterns. The system may adjust suggestion prioritization based on time of day, current location, seasonal relevance, and individual user history. This contextual processing may improve suggestion accuracy and may reduce the cognitive load on users by presenting the most relevant options first.

Privacy protection measures may ensure user data security while enabling intelligent processing. The system may implement data encryption, access controls, and user consent mechanisms to protect personal information. Users may retain control over data sharing preferences and may opt out of certain data collection practices while still benefiting from core suggestion functionality.

The solution may scale to accommodate diverse user needs and usage patterns through flexible architecture design. The system may support both cloud-based processing for complex analysis tasks and on-device processing for privacy-sensitive operations. This hybrid approach may optimize performance while respecting user preferences for data handling and processing location.

The present disclosure includes many aspects and features. Moreover, while many aspects and features relate to, and are described in, the context of intelligent action suggestion platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The proposed system provides a digital platform—referred to in certain embodiments as the Twos platform—that captures and transforms user-entered “things” (atomic pieces of information such as, but not limited to, notes, to-dos, events, and/or reminders) into direct, actionable steps without needing to switch between different apps. When a user enters information (such as a shopping list, text, or voice command), the system automatically analyzes and categorizes the input using artificial intelligence. The platform then creates smart suggestions, such as links to buy products, calendar entries for upcoming events, reminders, or directions to nearby locations. These suggestions are displayed for the user to select, and, with a tap or click, the platform can connect the user directly to the appropriate website, app, or service. The whole process is seamless, working across multiple devices and applications, and can also handle collaborative lists or shared tasks among multiple users.

The disclosed system may represent a comprehensive approach to transforming passive information capture into active task facilitation through intelligent processing and suggestion generation. The platform may operate by receiving diverse user inputs across multiple channels and automatically analyzing these inputs to provide contextually relevant actionable recommendations without requiring explicit user interaction with artificial intelligence interfaces.

The system may fundamentally address the disconnect between information recording and action execution that may characterize traditional productivity applications. Users may typically capture information in notes, lists, or documents but may then need to manually search for resources, switch between applications, or perform additional research to complete tasks related to their recorded information. The disclosed platform may eliminate this friction by automatically processing user input and generating smart suggestions that may connect users directly to relevant external platforms and internal device functions.

The core functionality may begin when users input information through various interfaces including mobile applications, web browsers, desktop clients, or integration with third-party services such as virtual assistants and messaging platforms. The system may accept text input, voice commands, shared content from other users, and imported data from external sources. This multi-modal input capability may ensure that users can capture information through their preferred methods without being constrained to specific interfaces or formats.

Upon receiving user input, the platform may automatically initiate a categorization process that may analyze the semantic content and contextual information to determine appropriate classifications. The categorization module may utilize natural language processing techniques and machine learning models to identify the type of content within the user input. The system may recognize and classify information into numerous categories including (but not limited to) products, books, authors, groceries, locations, restaurants, foods, music albums, artists, songs, movies, actors, television shows, concerts, events, sports, videos, electronics, birthdays, anniversaries, contacts, flights, hotels, rental cars, home services, professional services, freelance work, and employment opportunities.

The categorization process may support multiple category assignments for complex inputs that may contain diverse information types. For example, a user input mentioning a specific restaurant may be categorized under both restaurants and locations, enabling the system to generate suggestions related to both dining reservations and navigation assistance. The system may also generate confidence scores for each category assignment to ensure that suggestions may be relevant and appropriate for the identified content.

Following categorization, the platform may generate smart suggestions through artificial intelligence processing that may consider the determined categories along with additional contextual factors. The suggestion generation process may involve creating structured prompts that may include the categorized input, user location data, temporal information, and historical usage patterns. These prompts may be sent to machine learning models that may analyze the information and generate contextually appropriate suggestions.

The artificial intelligence models may process the prompts and return multiple suggestion candidates that may be relevant to the user input and categories. The system may then apply ranking algorithms and business logic to prioritize suggestions based on factors such as relevance, user engagement potential, and availability of external resources. This processing may ensure that users receive the most useful and actionable suggestions for their specific inputs and circumstances.

Smart suggestions may encompass connections to both external platforms and internal device capabilities. External suggestions may include links to e-commerce platforms for product purchases, streaming services for media content consumption, booking systems for travel arrangements, social media platforms for content sharing, job search platforms for employment opportunities, and professional service platforms for specialized assistance. The system may maintain real-time integration with these external platforms through application programming interfaces to ensure that suggestions remain current and actionable.

Internal suggestions may leverage existing device capabilities to provide seamless integration with personal productivity workflows. These may include creating calendar events for time-sensitive items, setting reminders for future tasks, adding contacts for recognized personal information, composing text messages or emails for communication needs, and generating to-do list items for actionable tasks. The system may access user data stores and device functions to execute these internal suggestions without requiring additional user configuration or setup.

The platform may implement affiliate link integration as a revenue generation mechanism while providing value to users. When suggestions include external commerce platforms, the system may embed tracking codes that may attribute transactions to the suggestion platform. This approach may create a sustainable business model that may support continued development and platform maintenance while ensuring users receive relevant suggestions without additional cost or subscription requirements. In one embodiment, affiliate tracking is performed through a link-management subsystem that embeds unique identifiers within hyperlink metadata stored in a relational database. The system verifies attribution by matching post-click callback events received via API webhooks from partner platforms.

Each affiliate link may include a cryptographically verifiable token to validate attribution without transmitting personal data.

Cross-platform synchronization may enable users to access their input data and generated suggestions from multiple devices associated with their user account. The system may maintain consistent suggestion availability whether users access the platform through mobile applications, web interfaces, or desktop clients. Synchronization may occur in real-time to ensure seamless transitions between devices while maintaining access to information and suggestions across the user's computing ecosystem.

The platform may incorporate analytics and learning capabilities to enhance suggestion quality over time through user interaction tracking and feedback analysis. The system may monitor which suggestions users select, how frequently different types of suggestions generate engagement, and patterns in user behavior across various content categories. This data may inform machine learning model improvements and suggestion algorithm refinements to increase relevance and utility for individual users and the broader user base.

Collaborative functionality may support scenarios where multiple users contribute to shared lists or information repositories. The system may analyze shared content using the same categorization and suggestion generation processes, enabling team productivity enhancement and collaborative task completion. Suggestions generated from shared content may be accessible to all authorized collaborators while maintaining appropriate privacy controls and access permissions.

The system may implement contextual awareness that may extend beyond simple content analysis to include temporal factors, geographic location, and user preference patterns. Suggestion prioritization may adjust based on time of day, current location, seasonal relevance, and individual user history. This contextual processing may improve suggestion accuracy and may reduce cognitive load on users by presenting the most relevant options first.

Privacy protection measures may ensure user data security while enabling intelligent processing capabilities. The system may implement data encryption, access controls, and user consent mechanisms to protect personal information. Users may retain control over data sharing preferences and may opt out of certain data collection practices while still benefiting from core suggestion functionality.

The disclosed platform may represent a scalable solution that may accommodate diverse user needs and usage patterns through flexible architecture design. The system may support both cloud-based processing for complex analysis tasks and on-device processing for privacy-sensitive operations. This hybrid approach may optimize performance while respecting user preferences for data handling and processing location.

The memory may store instructions that, when executed by the processor, implement a software-based categorization module, suggestion generation module, data transmission interface, and selection handling logic. Each of these modules may comprise subroutines or code segments that collectively enable the system to carry out operations, such as artificial intelligence-based categorization, context-aware suggestion generation, communication with user devices, and interaction with external platforms. The modules may be structured as discrete software libraries or as integrated components within a unified software application.

Upon execution, the processor may receive user input transmitted from a user device through a network interface or direct device connection. The received input may be temporarily buffered in memory and processed by the categorization software implemented as instructions in the same memory. Artificial intelligence processing, utilizing machine-learned models also stored in memory, may determine at least one category for the user input. The suggestion generation module may create at least one context-aware smart suggestion, which the processor may transmit to the user device for display using conventional communication protocols. User selections may be captured by the processor, which then identifies and provides a link, stored or generated in memory, to an external resource that is associated with the selected smart suggestion.

Embodiments of the present disclosure may comprise methods, systems, and a computer readable medium comprising, but not limited to, at least one of the following:
A. A User Interface
B. A Categorization Module
C. A Suggestion Module
D. A Suggestion Processing Module
E. A Communication Interface
F. An Artificial Intelligence Module

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving user input from a user device;
categorizing the user input into at least one category using artificial intelligence processing;
generating at least one smart suggestion based on the user input and the at least one category;
transmitting the at least one smart suggestion to the user device for display;
receiving a user selection of the at least one smart suggestion; and
providing a link to an external resource associated with the at least one smart suggestion in response to the user selection.

Although the aforementioned method has been described to be performed by the platform 100, it should be understood that computing device 300 may be used to perform the various stages of the method. Furthermore, in some embodiments, different operations may be performed by different networked elements in operative communication with computing device 300. For example, a plurality of computing devices may be employed in the performance of some or all of the stages in the aforementioned method. Moreover, a plurality of computing devices may be configured much like a single computing device 300. Similarly, an apparatus may be employed in the performance of some or all stages in the method. The apparatus may also be configured much like computing device 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

The disclosed system may provide comprehensive functionality for transforming user input into actionable recommendations through intelligent processing and contextual analysis. The platform may operate through multiple interconnected components that may work together to deliver seamless user experiences across various computing environments.

The system may receive user input through multiple channels including mobile applications, web interfaces, desktop clients, and third-party integrations. The user input may comprise text entries, voice commands, shared content from other users, or imported data from external sources. The platform may accommodate various input modalities to ensure users may capture information through their preferred methods without being constrained to specific interfaces or interaction patterns.

Upon receiving user input, the system may initiate automated processing that may analyze the semantic content and contextual information to determine appropriate categorizations. The categorization process may utilize artificial intelligence models that may examine the input text, extract relevant features, and assign categories based on learned patterns and predefined taxonomies. The system may support multiple category assignments for complex inputs that may contain diverse information types within a single entry.

The categorization module may access comprehensive taxonomies that may include categories such as products, books, authors, groceries, locations, restaurants, foods, music albums, artists, songs, movies, actors, television shows, concerts, events, sports, videos, electronics, birthdays, anniversaries, contacts, flights, hotels, rental cars, home services, professional services, freelance work, and employment opportunities. The system may dynamically expand these taxonomies to accommodate new content types and user needs as they emerge.

Following categorization, the platform may generate intelligent suggestions through artificial intelligence processing that may consider the determined categories along with contextual factors such as user location, temporal information, and historical usage patterns. The suggestion generation process may involve creating structured prompts that may be processed by machine learning models to produce contextually relevant recommendations. The artificial intelligence models may analyze the prompts and generate multiple suggestion candidates that may be ranked and filtered based on relevance and user engagement potential.

The system may integrate with numerous external platforms and services to provide actionable suggestions that may connect users directly to relevant resources. External integrations may include e-commerce platforms for product purchases, streaming services for media content consumption, booking systems for travel arrangements, social media platforms for content sharing, job search platforms for employment opportunities, and professional service platforms for specialized assistance. The platform may maintain real-time connections with these external services through application programming interfaces to ensure suggestion accuracy and availability.

Internal suggestions may leverage existing device capabilities to provide seamless integration with personal productivity workflows. The system may generate suggestions for creating calendar events, setting reminders, adding contacts, composing messages, and generating task list items. These internal functions may access user data stores and device capabilities to execute suggestions without requiring additional configuration or setup procedures.

The platform may implement revenue generation mechanisms through affiliate link integration that may embed tracking codes into external commerce suggestions. When users interact with these suggestions and complete transactions on external platforms, the system may receive attribution credits and commission payments. This revenue model may support continued platform development and maintenance while providing value to users without additional costs or subscription requirements.

Cross-platform synchronization may enable users to access their input data and generated suggestions from multiple devices associated with their user accounts. The system may maintain consistent suggestion availability whether users access the platform through mobile applications, web interfaces, or desktop clients. Synchronization may occur in real-time to ensure seamless transitions between devices while maintaining access to information and suggestions across the user's computing ecosystem.

The system may incorporate analytics and learning capabilities that may enhance suggestion quality over time through user interaction tracking and feedback analysis. The platform may monitor which suggestions users select, how frequently different types of suggestions generate engagement, and patterns in user behavior across various content categories. This data may inform machine learning model improvements and suggestion algorithm refinements to increase relevance and utility for individual users and the broader user base.

Collaborative functionality may support scenarios where multiple users contribute to shared lists or information repositories. The system may analyze shared content using the same categorization and suggestion generation processes, enabling team productivity enhancement and collaborative task completion. Suggestions generated from shared content may be accessible to all authorized collaborators while maintaining appropriate privacy controls and access permissions.

The platform may implement contextual awareness that may extend beyond simple content analysis to include temporal factors, geographic location, and user preference patterns. Suggestion prioritization may adjust based on time of day, current location, seasonal relevance, and individual user history. This contextual processing may improve suggestion accuracy and may reduce cognitive load on users by presenting the most relevant options first.

Privacy protection measures may ensure user data security while enabling intelligent processing capabilities. The system may implement data encryption, access controls, and user consent mechanisms to protect personal information. Users may retain control over data sharing preferences and may opt out of certain data collection practices while still benefiting from core suggestion functionality.

The disclosed platform may represent a scalable solution that may accommodate diverse user needs and usage patterns through flexible architecture design. The system may support both cloud-based processing for complex analysis tasks and on-device processing for privacy-sensitive operations. This hybrid approach may optimize performance while respecting user preferences for data handling and processing location.

The communication interface may facilitate seamless interaction between the platform and external platforms through application programming interfaces. The communication interface may establish secure connections with e-commerce platforms, social media services, streaming platforms, booking systems, and professional service providers to enable real-time data exchange and suggestion delivery. The interface may handle authentication protocols, data encryption, and error recovery mechanisms to ensure reliable communication with external resources.

The communication interface may support multiple communication protocols including HTTP, HTTPS, REST, and WebSocket connections to accommodate diverse external platform requirements. The interface may implement rate limiting and request throttling to manage API usage within external platform constraints while maintaining optimal system performance. Connection pooling and load balancing mechanisms may be employed to distribute communication requests efficiently across available network resources.

The communication interface may include caching mechanisms to store frequently accessed external data and reduce network latency. The interface may implement retry logic and fallback mechanisms to handle temporary network failures or external service outages gracefully. Real-time monitoring and logging capabilities may track communication performance and identify potential issues with external integrations.

The artificial intelligence module may serve as the core intelligence component that powers the categorization and suggestion generation capabilities of the platform 100. The artificial intelligence module may incorporate advanced natural language processing algorithms, machine learning models, and semantic analysis engines to understand and process user input with high accuracy and contextual awareness.

The artificial intelligence module may utilize transformer-based language models that have been trained on diverse datasets to recognize patterns, entities, and intent within user input text. The module may employ named entity recognition techniques to identify specific products, locations, people, dates, and other relevant information elements within user submissions. Context analysis algorithms may evaluate surrounding text and metadata to improve categorization accuracy and suggestion relevance.

The artificial intelligence module may implement multi-modal processing capabilities to handle various input types including text, voice transcriptions, and structured data from external integrations. The module may support multiple languages and regional dialects to accommodate diverse user bases and international market requirements. Continuous learning mechanisms may enable the module to adapt to new vocabulary, emerging trends, and evolving user behavior patterns over time.

The artificial intelligence module may include confidence scoring algorithms that evaluate the certainty of categorization decisions and suggestion quality. The module may implement ensemble methods that combine multiple AI models to improve overall accuracy and robustness of the intelligent processing pipeline. Model versioning and A/B testing capabilities may enable systematic evaluation and deployment of improved AI algorithms without service disruption.

The artificial intelligence module may incorporate privacy-preserving techniques such as federated learning and differential privacy to protect user data while maintaining high-quality AI performance. The module may support both cloud-based and on-device processing modes to accommodate different privacy requirements and network connectivity scenarios. Edge computing capabilities may enable reduced latency and improved user experience for time-sensitive processing tasks.

The suggestion processing module may transform raw AI-generated suggestions into polished, actionable recommendations that are optimized for user interaction and platform revenue generation. The suggestion processing module may apply business logic, formatting rules, and personalization algorithms to enhance the quality and relevance of suggestions presented to users.

The suggestion processing module may implement affiliate link integration mechanisms that automatically embed tracking codes and referral parameters into external resource links. The module may maintain partnerships with multiple affiliate networks and e-commerce platforms to maximize revenue opportunities while providing users with competitive pricing and product availability information. Dynamic link generation may ensure that affiliate codes are current and properly attributed to the platform.

The suggestion processing module may apply personalization algorithms that consider user preferences, historical behavior, geographic location, and temporal factors to prioritize and customize suggestions. The module may implement collaborative filtering techniques that leverage aggregated user behavior patterns to improve suggestion quality for individual users. Machine learning algorithms may continuously refine personalization models based on user feedback and interaction data.

The suggestion processing module may include content filtering and quality assurance mechanisms to ensure that suggestions meet platform standards and user expectations. The module may implement spam detection, inappropriate content filtering, and relevance scoring to maintain high-quality suggestion delivery. Real-time availability checking may verify that external resources and services are accessible before presenting suggestions to users.

The suggestion processing module may support A/B testing frameworks that enable systematic evaluation of different suggestion formats, ordering algorithms, and presentation styles. The module may implement analytics tracking that captures detailed metrics about suggestion performance, user engagement, and conversion rates. This data may inform continuous optimization of the suggestion generation and presentation processes.

The suggestion processing module may include template engines and formatting systems that ensure consistent visual presentation across different device types and user interface configurations. The module may support responsive design principles that adapt suggestion layouts to various screen sizes and input methods. Accessibility features may ensure that suggestions are usable by individuals with diverse abilities and assistive technologies.

The platform may operate within a distributed computing environment where the suggestion engine coordinates the activities of multiple specialized modules to deliver intelligent action suggestions. The user interface may serve as the primary interaction point between users and the platform, capturing input and displaying processed suggestions through the display component.

The external data source may represent the ecosystem of third-party services, APIs, and platforms that provide real-time information and services to enhance suggestion quality and actionability. The suggestion engine may orchestrate data flow between the user interface and external data source while applying intelligent processing through its constituent modules.

The modular architecture may enable scalable deployment across cloud computing environments, on-premises installations, and hybrid configurations. Each module may operate independently while maintaining standardized interfaces for seamless integration and data exchange. This architecture may support horizontal scaling by distributing module instances across multiple computing resources based on demand and performance requirements.

The platform may implement comprehensive security measures including data encryption, access controls, and audit logging to protect user information and maintain system integrity. Authentication and authorization mechanisms may ensure that only authorized users and systems can access platform functionality and data resources. Regular security assessments and updates may maintain protection against emerging threats and vulnerabilities.

The platform may support multi-tenancy capabilities that enable multiple organizations or user groups to utilize the system while maintaining data isolation and customized configurations. Administrative interfaces may provide system operators with monitoring, configuration, and maintenance capabilities to ensure optimal platform performance and reliability.

The platform may support alternative embodiments that provide users with diverse approaches to intelligent action suggestion generation and delivery. These alternative configurations may enhance system flexibility and may accommodate varying user preferences and operational requirements.

The user interface may be embodied in alternative forms that may extend beyond traditional screen-based interactions. Voice-activated interfaces may enable users to input information through natural speech patterns, with the system processing spoken content through advanced speech recognition algorithms. The voice interface may support multiple languages and may adapt to individual speech patterns and accents over time. Touch-sensitive surfaces may provide haptic feedback mechanisms that may allow users to interact with suggestions through gesture-based commands. Augmented reality interfaces may overlay smart suggestions directly onto real-world objects captured through camera systems, enabling contextual interaction with physical environments.

The categorization module may employ alternative classification approaches that may provide enhanced accuracy and contextual understanding. Hierarchical categorization systems may organize content into nested category structures, enabling more granular classification and specialized suggestion generation. Multi-dimensional categorization may assign content to multiple category axes simultaneously, such as temporal relevance, geographic specificity, and user preference alignment. Dynamic categorization may adjust category assignments based on evolving user behavior patterns and external data trends. Collaborative categorization may incorporate feedback from multiple users to refine category definitions and improve classification accuracy across the platform.

Alternative suggestion generation methods may provide users with varied approaches to actionable recommendation delivery. Predictive suggestion systems may anticipate user needs based on historical patterns and may generate proactive recommendations before explicit user requests. Contextual suggestion engines may incorporate real-time environmental data such as location, time of day, weather conditions, and calendar events to enhance suggestion relevance. Collaborative filtering approaches may leverage aggregated user behavior data to generate suggestions based on similar user profiles and preferences. Machine learning ensemble methods may combine multiple AI models to generate diverse suggestion candidates and may select optimal recommendations through consensus algorithms.

The artificial intelligence module may incorporate alternative processing architectures that may enhance system performance and accuracy. Distributed processing systems may utilize multiple AI models operating in parallel to handle different aspects of content analysis and suggestion generation. Edge computing implementations may perform AI processing locally on user devices to reduce latency and enhance privacy protection. Federated learning approaches may enable model improvement through collaborative training across multiple user devices while maintaining data privacy. Specialized neural network architectures may be optimized for specific content types, such as image recognition for visual inputs or natural language processing for textual content.

Alternative revenue generation models may provide platform sustainability through diverse monetization approaches. Subscription-based services may offer premium features such as advanced suggestion algorithms, priority processing, or enhanced customization options. Freemium models may provide basic functionality at no cost while charging for advanced features or increased usage limits. Transaction-based fees may be collected from successful referrals to external platforms, with rates varying based on transaction value or platform partnerships. Data insights services may provide aggregated usage analytics to business partners while maintaining individual user privacy through anonymization techniques.

Cross-platform synchronization may be implemented through alternative architectures that may accommodate diverse user device ecosystems. Cloud-based synchronization may maintain centralized user data storage with real-time updates across all connected devices. Peer-to-peer synchronization may enable direct device-to-device data sharing without requiring central server infrastructure. Hybrid synchronization approaches may combine cloud and local storage to optimize performance and reliability. Blockchain-based synchronization may provide decentralized data management with enhanced security and user control over personal information.

Alternative user interaction models may provide diverse approaches to suggestion presentation and selection. Progressive disclosure interfaces may present suggestions in staged layers, revealing additional options based on user engagement levels. Conversational interfaces may enable users to refine suggestions through natural language dialogue with AI assistants. Gesture-based interaction systems may allow users to manipulate suggestions through hand movements or eye tracking. Ambient computing approaches may integrate suggestions seamlessly into user environments through smart home devices and Internet of Things platforms.

The suggestion processing module may employ alternative optimization strategies that may enhance suggestion quality and user engagement. A/B testing frameworks may continuously evaluate different suggestion formats and presentation styles to identify optimal user experience configurations. Personalization engines may adapt suggestion presentation based on individual user preferences, device capabilities, and usage contexts. Real-time optimization algorithms may adjust suggestion ranking and filtering based on current user behavior and external factors. Multi-objective optimization may balance competing factors such as user relevance, business value, and system performance constraints.

Alternative data integration approaches may expand the scope and accuracy of suggestion generation. Social media integration may incorporate user activity from external platforms to enhance contextual understanding and suggestion relevance. Internet of Things data streams may provide environmental context from connected devices to inform suggestion timing and content. Third-party service APIs may enable real-time data retrieval from external platforms to ensure suggestion accuracy and availability. Sensor data integration may incorporate information from mobile device sensors such as accelerometers, GPS, and ambient light sensors to enhance contextual awareness.

Privacy-preserving alternatives may provide users with enhanced control over personal data while maintaining system functionality. Differential privacy techniques may add statistical noise to user data to prevent individual identification while preserving aggregate utility. Homomorphic encryption may enable AI processing on encrypted data without requiring decryption. Local processing alternatives may perform suggestion generation entirely on user devices to minimize data transmission. Zero-knowledge architectures may enable system functionality without requiring access to sensitive user information.

Alternative deployment models may accommodate diverse organizational and technical requirements. On-premises installations may provide complete control over data processing and storage for security-sensitive environments. Hybrid cloud deployments may combine local processing with cloud-based AI services to balance performance and privacy requirements. Multi-tenant architectures may enable service providers to offer the platform to multiple organizations while maintaining data isolation. Open-source implementations may allow organizations to customize and extend platform functionality according to specific requirements.

Accessibility alternatives may ensure platform usability across diverse user populations and capabilities. Screen reader compatibility may provide audio descriptions of suggestions and interface elements for visually impaired users. High contrast visual modes may enhance readability for users with visual processing difficulties. Simplified interface options may reduce cognitive load for users with learning disabilities or attention challenges. Multi-modal input support may accommodate users with motor impairments through alternative interaction methods such as eye tracking or voice commands.

Alternative learning mechanisms may enhance system adaptation and improvement over time. Reinforcement learning approaches may optimize suggestion quality through continuous user feedback and interaction monitoring. Transfer learning techniques may apply knowledge gained from one user domain to improve suggestions in related areas. Active learning strategies may identify optimal training examples to improve AI model performance with minimal data requirements. Incremental learning methods may enable continuous model updates without requiring complete retraining processes.

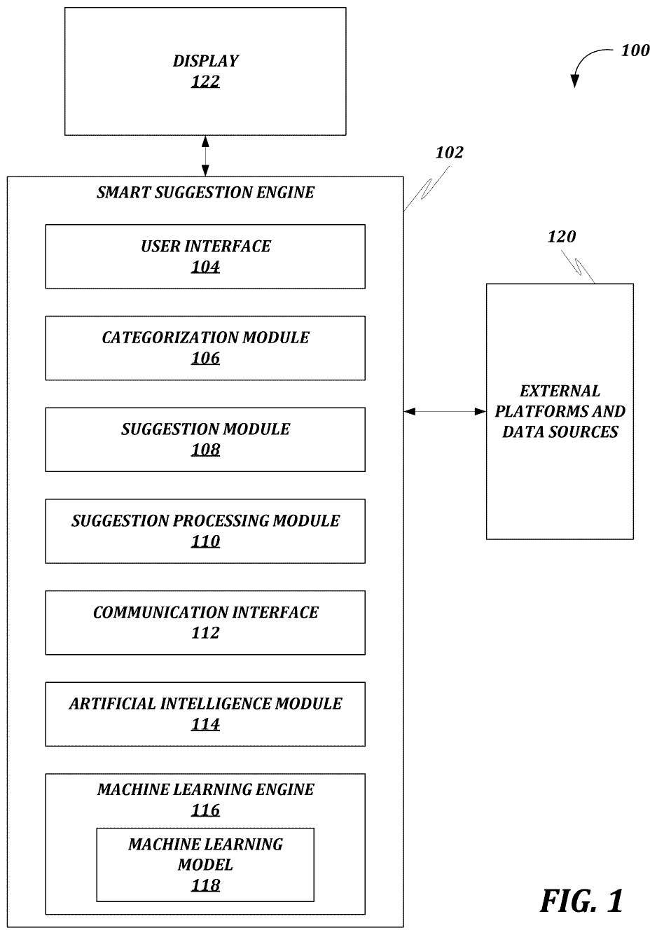

FIG. 1 illustrates one possible operating environment through which a platform consistent with embodiments of the present disclosure may be provided. By way of non-limiting example, an intelligent action suggestion platform 100 may include a smart suggestion engine 102 hosted on, for example, a cloud computing service. In some embodiments, the platform 100 may be hosted on a computing device 300. A user may access platform 100 (and thus the smart suggestion engine 102) through a software application and/or hardware device. The software application may be embodied as, for example, but not be limited to, a website, a web application, a desktop application, and a mobile application compatible with the computing device 300.

Accordingly, embodiments of the present disclosure provide a software and hardware platform comprised of a distributed set of computing elements, including, but not limited to:

### A. A User Interface

The smart suggestion engine 102 may include a user interface 104. The user interface 104 may include hardware and/or software configured for facilitating user interaction with the platform. The user interface 104 may comprise a display component 122 configured to present visual information to users. The display component 122 may render smart suggestions, user input fields, interactive elements through which users may engage with the suggestion engine 102, and/or the like. The display component 122 may support multiple display formats including text-based interfaces, graphical user interfaces, multimedia presentations, etc. to accommodate diverse user preferences and device capabilities.

The user interface 104 may include an input component configured to receive user input through various modalities. The input component may support text entry through keyboard interfaces, voice input through microphone systems, touch input through touchscreen interfaces, gesture-based input through motion detection systems, input received via a pointing device (e.g., a mouse, trackpad, trackball, etc.), and/or the like. The input component may process multi-modal input substantially simultaneously, enabling users to combine different input methods within a single interaction session.

The user interface 104 may incorporate a navigation component that may enable users to move between different sections and features of the platform. The navigation component may provide menu systems, breadcrumb navigation, search functionality, and quick access shortcuts to frequently used features. The navigation component may adapt its presentation based on the current user context and device form factor to optimize usability across different platforms.

The user interface 104 may include a feedback component configured to provide real-time responses to user actions and system status updates. The feedback component may display loading indicators during processing operations, confirmation messages following successful actions, error notifications when issues occur, and progress indicators for long-running tasks. The feedback component may utilize visual, auditory, and/or haptic feedback mechanisms to ensure users remain informed about system operations.

The user interface 104 may feature a customization component that may allow users to personalize their interface experience according to individual preferences and requirements. The customization component may enable users to modify color schemes, adjust font sizes, rearrange interface elements, and/or configure notification settings. The customization component may store user preferences persistently and may synchronize customization settings across multiple devices associated with the same user account.

The user interface 104 may incorporate an accessibility component designed to ensure the platform remains usable by individuals with diverse abilities and assistive technology requirements. The accessibility component may provide screen reader compatibility, high contrast visual modes, keyboard navigation alternatives, and voice command support. The accessibility component may comply with established accessibility standards and guidelines to promote inclusive user experiences.

In some embodiments, the user interface may present smart suggestions as a dynamic list immediately adjacent to or beneath the user's original input field. Each smart suggestion may be represented by an interactive button, icon, or hyperlink that the user can select to initiate a corresponding action. For example, when a user types a grocery item such as “milk,” a smart suggestion for purchasing milk may appear as a button labeled “Buy Milk,” which, when pressed, directs the user to an e-commerce partner or adds the item to a shopping list. Visual cues, such as a highlight color or a designated icon (e.g., a diamond or lightbulb), may indicate actionable suggestions. The interface may further support hovering, tapping, or keyboard navigation to select among multiple concurrent suggestions. In mobile embodiments, suggestions may be presented as swipeable cards below the input field. All elements may be accessible via assistive technologies and dynamically update as new input is entered.

The user interface 104 may include a synchronization component that may maintain consistency of user interface state across multiple devices and sessions. The synchronization component may preserve user interface preferences, session data, and interaction history to enable seamless transitions between different devices and platforms. The synchronization component may operate in real-time to ensure users experience consistent interface behavior regardless of their access method.

The user interface 104 may feature a notification component configured to deliver timely information and alerts to users through appropriate channels. The notification component may display in-application notifications, system-level alerts, email notifications, and/or push notifications to mobile devices. The notification component may respect user preferences regarding notification frequency, timing, and delivery methods to avoid overwhelming users with excessive communications.

### B. A Categorization Module

The smart suggestion engine 102 may include a user interface 104. The user interface 104 may include hardware and/or software configured to analyze the semantic content and contextual information within user input for assignment into one or more of a plurality of categories. The categorization module 106 may employ natural language processing techniques, and/or may utilize machine learning algorithms that may examine textual patterns, entity recognition, contextual clues, and/or the like to determine appropriate category assignments. The categorization process may involve tokenization of input text, extraction of relevant features, and comparison against predefined category taxonomies stored in system memory.

The categorization module 106 may implement confidence scoring mechanisms that may evaluate the certainty of category assignments. The module may generate numerical confidence values for each potential category match, enabling the system to prioritize high-confidence categorizations while flagging uncertain classifications for additional processing. Multiple categories may be assigned to a single input when the content spans different domains or contains diverse information types.

The categorization module 106 may access comprehensive category databases that may include product classifications, entertainment content types, service categories, location identifiers, and personal information types. The module may continuously update these taxonomies based on emerging content types and user interaction patterns. Dynamic category expansion may occur through machine learning processes that may identify new content patterns and suggest additional classification options. In one embodiment, each user input is represented as a JSON-based data object containing fields for items such as id, content, category, confidence_score, and metadata (e.g., timestamp, device type, location). This structured representation enables efficient retrieval and cross-platform synchronization. Those of skill in the art will recognize that various embodiments may represent each object may have more, fewer, and/or different fields without departing from the scope of this invention.

The categorization module 106 may incorporate contextual analysis capabilities that may consider temporal factors, geographic information, user behavior patterns, etc. when determining categories. The module may analyze metadata associated with user input, including timestamps, device information, and input methods to enhance categorization accuracy. Historical user data may inform category selection by identifying patterns in user preferences and content types.

The categorization module 106 may support multi-language processing capabilities that may analyze content in various languages and regional dialects. The module may employ language detection algorithms to identify input language and apply appropriate linguistic processing techniques. Cross-language category mapping may ensure consistent categorization across different language inputs.

The categorization module 106 may implement real-time processing capabilities that may analyze user input as it is entered or immediately upon submission. The module may optimize processing speed through parallel processing techniques and efficient algorithm implementations. Batch processing modes may handle multiple inputs simultaneously for improved system throughput.

The categorization module 106 may include error handling and fallback mechanisms that may manage uncertain or ambiguous input content. The module may implement default categorization strategies for unrecognized content types and may flag unusual inputs for manual review. Quality assurance processes may monitor categorization accuracy and identify areas for improvement.

The categorization module 106 may support collaborative categorization features that may leverage aggregated user behavior data to improve classification accuracy. The module may analyze patterns across multiple users to identify common categorization preferences and refine category definitions. Feedback mechanisms may allow users to correct categorization errors, contributing to system learning and improvement.

This process improves computing efficiency by reducing redundant processing and enabling real-time action generation.

In an illustrative embodiment, when a user submits the input “Dinner with Sarah at 7 pm,” the categorization module preprocesses the phrase using text normalization, tokenizes the words, and applies named entity recognition to detect the time (“7 pm”), activity (“Dinner”), and contact (“Sarah”). Using a pre-defined taxonomy, the module identifies relevant categories: “event,” “contact,” and “reminder.” The AI model generates a confidence score for each assigned category (e.g., event=0.95, reminder=0.85, contact=0.90). Based on these scores and training parameters, the module assigns the input to “event” and triggers downstream suggestion generation steps for creating a calendar entry and sending an invitation. Configuration parameters, such as minimum score thresholds and category ranking rules, may be set by system administrators or learned from user behavior.

### C. A Suggestion Module

The engine 102 may include a suggestion module 108. The suggestion module 108 may include hardware and/or software configured to generate contextually relevant smart suggestion candidates that may connect users directly to relevant external platforms and/or internal device functions. The suggestion module 108 may operate through artificial intelligence processing that may analyze categorized user input and may determine appropriate actionable recommendations based on content analysis and contextual factors.

The suggestion module may generate actionable smart suggestions by first matching the assigned category to possible actions, then querying available external APIs and internal device functions. A scoring/ranking process may consider user profile, location, device type, and previously accepted suggestions to order the possible options. The module may format the highest-ranking suggestions as interactive UI elements—buttons, links, or list entries. In response to user selection, the system may log the engagement and, where applicable, update future suggestion relevance. Actions may include making purchases, creating calendar events, initiating communications, or generating content links.

The suggestion module 108 may receive categorized input data from the categorization module 106 and may process this information to generate multiple suggestion candidates. The module may utilize machine learning algorithms that may evaluate the semantic content of user input along with associated category assignments to determine relevant suggestion types. The processing may involve creating structured prompts that may include the categorized input, confidence scores from the categorization process, and additional contextual metadata such as user location, temporal information, and historical usage patterns.

In one embodiment, when the system identifies a “restaurant” category, it may query an external reservation API such as OpenTable using parameters {e.g., location, date, cuisine} derived from the structured object metadata. The API response may be parsed and ranked by relevance before presenting actionable booking links within the user interface.

The suggestion module 108 may interface with artificial intelligence models (e.g., the artificial intelligence module 112, the machine learning engine 114 and machine learning model 116, and/or one or more external AI models) that may analyze the structured prompts and generate contextually appropriate suggestion candidates. The module 108 may send formatted requests to external AI services and/or may utilize on-device machine learning models depending on system configuration and privacy requirements. The AI processing may consider multiple factors including content semantics, category relationships, user preferences, and external platform availability to generate diverse suggestion options.

The suggestion module 108 may implement ranking algorithms that may prioritize suggestion candidates based on one or more of relevance scores, user engagement potential, and business logic considerations. The module 108 may evaluate each suggestion candidate against multiple criteria including content match accuracy, external platform availability, user historical preferences, and revenue generation opportunities. The ranking process may ensure that the most appropriate and actionable suggestion candidates may be presented to users first.

The suggestion module 108 may support multi-platform integration capabilities that may enable connections to diverse external services and internal device functions. The module 108 may maintain real-time connections with e-commerce platforms, streaming services, booking systems, social media platforms, and professional service providers through application programming interfaces. Internal suggestions may leverage device capabilities such as calendar management, contact creation, reminder setting, and communication functions. Unlike conventional rule-based suggestion engines, the module 108 operates on dynamically generated embeddings stored in a vector database, allowing similarity matching and contextual recall of prior user “things.” This reduces redundant computation and latency.

The suggestion module 108 may incorporate personalization mechanisms that may adapt suggestion candidate generation based on individual user behavior patterns and preferences. The module 108 may analyze historical user interactions with suggestions to identify preference trends and may adjust future suggestion candidate generation accordingly. The personalization process may consider factors such as (but not limited to) frequently selected suggestion types, preferred external platforms, and/or user engagement patterns across different content categories.

The suggestion module 108 may implement collaborative suggestion features that may analyze shared content and may generate suggestions relevant to multiple users in collaborative scenarios. The module may process shared lists, notes, and other collaborative content using the same categorization and suggestion generation processes while maintaining appropriate access controls and privacy protections. Collaborative suggestions may be accessible to all authorized participants in shared content scenarios.

The suggestion module 108 may support batch processing capabilities that may analyze multiple user inputs simultaneously and may generate one or more suggestions candidates that may encompass multiple related items. In some embodiments, the module 108 may identify relationships between different user inputs input at distinct times, and may create consolidated suggestions that may address multiple items within a single actionable recommendation. This functionality may be particularly useful for scenarios such as shopping lists, travel planning, and project management.

The suggestion module 108 may include feedback processing mechanisms that may capture user interactions with generated suggestions and may utilize this data to improve future suggestion quality. The module may track suggestion selection rates, user engagement patterns, and completion rates for different suggestion types. This feedback data may inform machine learning model improvements and may enable continuous refinement of suggestion generation algorithms.

The suggestion module 108 may implement contextual awareness features that may adjust suggestion generation based on temporal factors, geographic location, and environmental conditions. The module may consider time of day, seasonal relevance, user location, and current events when generating suggestions. This contextual processing may enhance suggestion relevance and may increase the likelihood of user engagement with generated recommendations.

The suggestion module 108 may support alternative suggestion generation modes that may accommodate different user preferences and usage scenarios. The module may provide options for conservative suggestion generation that may focus on high-confidence recommendations, exploratory modes that may suggest diverse options for user consideration, and automated modes that may generate suggestions without explicit user requests. These alternative modes may provide flexibility in how users interact with the suggestion system.

This process improves computing efficiency by reducing redundant processing and enabling real-time action generation.

### D. A Suggestion Processing Module

The engine 102 may include a suggestion processing module 110. The suggestion processing module 110 may include hardware and/or software configured to transform raw AI-generated suggestions into polished, actionable recommendations that may be optimized for user interaction and platform revenue generation. The suggestion processing module 110 may apply business logic, formatting rules, personalization algorithms and/or the like to the generated suggestion candidates to enhance the quality and relevance of suggestions presented to users.

The suggestion processing module 110 may receive raw suggestion candidates from the suggestion module 108 and may apply various processing operations to prepare these suggestions for user presentation. The module may analyze each suggestion candidate to determine appropriate formatting, metadata association, and presentation characteristics based on the suggestion type, user preferences, and device capabilities. The processing operations may include text formatting, link validation, metadata enrichment, and quality assurance checks to ensure that suggestions meet platform standards.

The suggestion processing module 110 may implement affiliate link integration mechanisms that may automatically embed tracking codes and/or referral parameters into external resource links. The module may maintain partnerships with multiple affiliate networks and e-commerce platforms to maximize revenue opportunities, provide users with competitive pricing and product availability information, and/or track user behavior on external, independent systems controlled by an entity other than the controller of the platform 100. Dynamic link generation may ensure that affiliate codes remain current and properly attributed to the platform while maintaining link functionality across different external platforms.

The suggestion processing module 110 may apply personalization algorithms that may consider one or more factors such as (but not limited to) user preferences, historical behavior patterns, geographic location, and/or temporal factors to customize suggestion presentation. The module may implement collaborative filtering techniques that may leverage aggregated user behavior patterns to improve suggestion quality for individual users. Machine learning algorithms may continuously refine personalization models based on user feedback and interaction data to enhance suggestion relevance over time.

The suggestion processing module 110 may include content filtering and quality assurance mechanisms that may ensure suggestions meet platform standards and user expectations. The module may implement spam detection algorithms, inappropriate content filtering systems, and relevance scoring mechanisms to maintain high-quality suggestion delivery. Real-time availability checking may verify that external resources and services remain accessible before presenting suggestions to users, preventing broken links and unavailable services. The system may employ hash-based verification to prevent duplicate link presentation and may maintain a local cache of resolved external resources, thereby reducing bandwidth and improving response times.

The suggestion processing module 110 may support A/B testing frameworks that may enable systematic evaluation of different suggestion formats, ordering algorithms, and presentation styles. The module may implement analytics tracking capabilities that may capture detailed metrics about suggestion performance, user engagement rates, and conversion statistics. This data may inform continuous optimization of the suggestion generation and presentation processes to improve user satisfaction and platform effectiveness.

The suggestion processing module 110 may include template engines and formatting systems that may ensure consistent visual presentation across different device types and user interface configurations. The module may support responsive design principles that may adapt suggestion layouts to various screen sizes and input methods. Accessibility features may ensure that suggestions remain usable by individuals with diverse abilities and assistive technologies.

The suggestion processing module 110 may implement caching mechanisms that may store frequently accessed suggestion templates and formatting rules to improve processing speed and system responsiveness. The module may support batch processing capabilities that may handle multiple suggestion candidates simultaneously to optimize system throughput during peak usage periods. Error handling and recovery mechanisms may ensure graceful degradation when external services become unavailable or processing errors occur.

The suggestion processing module 110 may incorporate feedback processing capabilities that may analyze user interactions with processed suggestions to identify areas for improvement. The module may track suggestion selection rates, user engagement patterns, and completion rates for different suggestion types and formats. This feedback data may inform iterative improvements to processing algorithms and presentation strategies to enhance overall system effectiveness.

### E. A Communication Interface

The engine 102 may include a communication interface 112. The communication interface 112 may include hardware and/or software configured to facilitate seamless interaction between the platform 100 and external platforms (e.g., through application programming interfaces). The communication interface 112 may establish secure connections with e-commerce platforms, social media services, streaming platforms, booking systems, and/or professional service providers to enable real-time data exchange and suggestion delivery. The interface 112 may handle authentication protocols, data encryption, and error recovery mechanisms to ensure reliable communication with external resources.

The communication interface 112 may support multiple communication protocols including (but not limited to) HTTP, HTTPS, REST, and WebSocket connections to accommodate diverse external platform requirements. The interface may implement rate limiting and request throttling to manage API usage within external platform constraints while maintaining optimal system performance. Connection pooling and load balancing mechanisms may be employed to distribute communication requests efficiently across available network resources.

The communication interface 112 may include caching mechanisms to store frequently accessed external data and reduce network latency. The interface may implement retry logic and fallback mechanisms to handle temporary network failures or external service outages gracefully. Real-time monitoring and logging capabilities may track communication performance and identify potential issues with external integrations.

The communication interface 112 may maintain persistent connections with high-priority external platforms to minimize connection establishment overhead for frequently accessed services. The interface may support batch processing capabilities to aggregate multiple requests to the same external platform, reducing network overhead and improving overall system efficiency. Quality of service mechanisms may prioritize critical communications while managing bandwidth allocation across different external platform integrations.

The communication interface 112 may implement security protocols including OAuth authentication, API key management, and encrypted data transmission to protect sensitive information during external communications. The interface may support webhook functionality to receive real-time updates from external platforms, enabling the system to maintain current information about product availability, pricing, and service status. Certificate management and validation processes may ensure secure communications with trusted external platforms while preventing unauthorized access attempts.

The communication interface 112 may include analytics and reporting capabilities to track communication patterns, response times, and error rates across different external platform integrations. The interface may support A/B testing frameworks to evaluate different communication strategies and optimize performance based on measured results. Load balancing algorithms may distribute communication requests across multiple external platform endpoints to ensure high availability and fault tolerance.

The communication interface 112 may provide abstraction layers that standardize communication protocols across different external platforms, simplifying integration maintenance and enabling rapid addition of new external services. The interface may support versioning mechanisms to handle API changes from external platforms without disrupting system functionality. Configuration management capabilities may allow dynamic adjustment of communication parameters based on external platform requirements and system performance metrics.

### F. An Artificial Intelligence Module

The engine 102 may include an artificial intelligence module 114. The artificial intelligence module 114 may include hardware and/or software configured to process natural language input and generate contextually appropriate suggestions. The artificial intelligence module 114 may comprise sophisticated machine learning architectures. For example, the artificial intelligence module 114 may incorporate transformer-based neural networks that may analyze semantic relationships within user input text. Additionally or alternatively, the module 114 may utilize pre-trained language models that may have been exposed to diverse textual datasets during training phases.

The artificial intelligence module 114 may implement attention mechanisms that may focus on relevant portions of user input when determining categories and generating suggestions. The module may employ multi-head attention layers that may process different aspects of the input simultaneously. The attention weights may be dynamically adjusted based on the contextual relevance of different input segments.

The artificial intelligence module 114 may include natural language understanding components that may extract entities, intents, and contextual information from user input. The module may recognize named entities such as product names, locations, dates, and personal names within the input text. The entity recognition may be performed through conditional random fields or neural sequence labeling approaches.

The artificial intelligence module 114 may incorporate semantic embedding techniques that may represent words and phrases as dense vector representations. The embeddings may capture semantic relationships between different concepts and may enable the system to understand synonyms and related terms. The vector representations may be learned through unsupervised training on large text corpora.

The artificial intelligence module 114 may implement contextual reasoning capabilities that may consider the broader context surrounding user input. The module may analyze previous user interactions, temporal patterns, and environmental factors when processing new input. The contextual information may be encoded as additional features that may influence the categorization and suggestion generation processes.

The artificial intelligence module 114 may utilize ensemble methods that may combine predictions from multiple machine learning models. The ensemble approach may improve robustness and accuracy by leveraging the strengths of different model architectures. The final predictions may be determined through weighted voting or stacking techniques that may optimize overall system performance.

A machine learning engine 116 may serve as the computational framework that may train, deploy, and manage machine learning models within the artificial intelligence module 114. The machine learning engine 116 may implement distributed training algorithms that may scale across multiple processing units. The engine may support both batch training and online learning paradigms depending on the specific requirements of different models.

The machine learning engine 116 may incorporate automated hyperparameter optimization techniques that may systematically search for optimal model configurations. The engine may employ Bayesian optimization, grid search, or evolutionary algorithms to identify hyperparameter settings that may maximize model performance. The optimization process may be guided by cross-validation metrics and may consider computational efficiency constraints.

The machine learning engine 116 may implement model versioning and deployment management capabilities that may enable seamless updates to production systems. The engine may maintain multiple model versions simultaneously and may support A/B testing frameworks for comparing model performance. The deployment process may include automated testing and validation procedures that may ensure model quality before production release.

The machine learning engine 116 may provide model monitoring and performance tracking capabilities that may detect degradation in model accuracy over time. The engine may implement drift detection algorithms that may identify when input data distributions change significantly from training data. The monitoring system may trigger retraining procedures when performance metrics fall below acceptable thresholds.

The machine learning engine 116 may support federated learning approaches that may enable model training across distributed data sources while preserving privacy. The engine may coordinate training updates from multiple client devices and may aggregate model parameters without requiring centralized data collection. The federated approach may be particularly beneficial for personalization while maintaining user privacy.

The machine learning engine 116 may implement active learning strategies that may identify the most informative training examples for model improvement. The engine may select examples that may maximize learning efficiency and may reduce the amount of labeled data required for training. The active learning process may be integrated with user feedback mechanisms to continuously improve model performance.

A machine learning model 118 may represent the trained neural network or statistical model that may perform the core categorization and suggestion generation tasks. The machine learning model 118 may be implemented as a multi-task learning architecture that may simultaneously predict categories and generate suggestions. The shared representations may enable the model to leverage commonalities between different tasks and may improve overall efficiency.

The machine learning model 118 may incorporate attention-based architectures that may dynamically focus on relevant input features during inference. The attention mechanisms may be learned during training and may adapt to different types of input content. The model may utilize self-attention layers that may capture long-range dependencies within input sequences.

The machine learning model 118 may implement hierarchical classification structures that may organize categories into taxonomic relationships. The hierarchical approach may enable the model to make predictions at different levels of granularity and may provide more nuanced categorization results. The model may learn to predict both broad category types and specific subcategories simultaneously.

The machine learning model 118 may incorporate uncertainty quantification techniques that may provide confidence estimates for predictions. The model may output probability distributions over possible categories rather than single point predictions. The uncertainty estimates may be used to identify cases where human review or additional processing may be beneficial.

The machine learning model 118 may support incremental learning capabilities that may enable continuous adaptation to new data without requiring complete retraining. The model may employ techniques such as elastic weight consolidation or progressive neural networks to retain knowledge from previous training while incorporating new information. The incremental learning approach may enable personalization and adaptation to evolving user preferences.

The machine learning model 118 may implement multi-modal processing capabilities that may handle different types of input data beyond text. The model may process images, audio, or structured data in addition to natural language input. The multi-modal architecture may enable richer understanding of user intent and may support more comprehensive suggestion generation.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Method for Suggesting Intelligent Actions Based on User Input

Consistent with embodiments of the present disclosure, a method may be performed by at least one of the aforementioned modules. The method may be embodied as, for example, but not limited to, computer instructions, which, when executed, perform the method.

The method may provide comprehensive functionality for transforming passive information capture into actionable task facilitation through intelligent processing and contextual suggestion generation. Users may input information through various interfaces including text entry, voice commands, or shared content from other users. The platform may automatically analyze this input using artificial intelligence techniques to determine appropriate content categories without requiring explicit user interaction with AI interfaces.

The categorization process may utilize natural language processing to examine semantic content and assign appropriate classifications from a comprehensive taxonomy. Categories may include products, books, authors, groceries, locations, restaurants, foods, music albums, artists, songs, movies, actors, television shows, concerts, events, sports, videos, electronics, birthdays, anniversaries, contacts, flights, hotels, rental cars, home services, professional services, freelance work, and employment opportunities. The system may assign multiple categories to complex inputs and may generate confidence scores for each category assignment. As one specific, non-limiting example, when a user records (or otherwise enters as user input) “Book dinner at Osteria Friday,” the platform detects an event category (“dinner”), a location entity (“Osteria”), and a temporal reference (“Friday”). The suggestion engine then generates (a) a reservation link via a booking API, (b) a map link via location services, and (c) a calendar entry through the device's native event framework. In another non-limiting example, when a user writes (or otherwise enters as user input) “Buy running shoes,” the system may identify a product-related category, query one or more e-commerce APIs, and generate a ranked list of purchase options. Each generated link may optionally include affiliate tracking parameters within the URL metadata to support attribution and performance analytics.

Following categorization, the platform may generate smart suggestions through artificial intelligence processing that considers both the determined categories and additional contextual factors. The system may create structured prompts that incorporate the categorized input along with user location data, temporal information, and historical usage patterns. These prompts may be processed by machine learning models to produce contextually relevant suggestions that connect users to both external platforms and internal device capabilities.

External suggestions may include connections to e-commerce platforms for product purchases, streaming services for media content, booking systems for travel arrangements, social media platforms for content sharing, job search platforms for employment opportunities, and professional service platforms for specialized assistance. The system may maintain real-time integration with these external platforms through application programming interfaces to ensure suggestion accuracy and availability.

Internal suggestions may leverage existing device capabilities to provide seamless integration with personal productivity workflows. These may include creating calendar events for time-sensitive items, setting reminders for future tasks, adding contacts for recognized personal information, composing text messages or emails for communication needs, and generating to-do list items for actionable tasks. The system may access user data stores and device functions to execute these internal suggestions without requiring additional user configuration.

The platform may implement affiliate link integration as a revenue generation mechanism while providing value to users. When suggestions include external commerce platforms, the system may embed tracking codes that attribute transactions to the suggestion platform. This approach may create a sustainable business model that supports continued development and platform maintenance while ensuring users receive relevant suggestions without additional cost.

Cross-platform synchronization may enable users to access their input data and generated suggestions from multiple devices associated with their user accounts. The system may maintain consistent suggestion availability whether users access the platform through mobile applications, web interfaces, or desktop clients. Synchronization may occur in real-time to ensure seamless transitions between devices while maintaining access to information and suggestions across the user's computing ecosystem.

Upon generation of smart suggestions, the platform may record both the original user input and the associated suggestions in a cloud-based database, mapping all records to the user account. When a user signs in on a secondary device, such as moving from a desktop application to a mobile app, the synchronization component retrieves both pending and historical suggestions, ensuring the user experiences continuity. Interaction data—including selection rates, dismissed suggestions, and completed tasks—are logged alongside device and context metadata. This engagement data may be processed by analytics services and used to retrain the artificial intelligence models, automatically improving the accuracy and personalization of future suggestions.

The platform may incorporate analytics and learning capabilities to enhance suggestion quality over time through user interaction tracking and feedback analysis. The system may monitor which suggestions users select, how frequently different types of suggestions generate engagement, and patterns in user behavior across various content categories. This data may inform machine learning model improvements and suggestion algorithm refinements to increase relevance and utility for individual users.

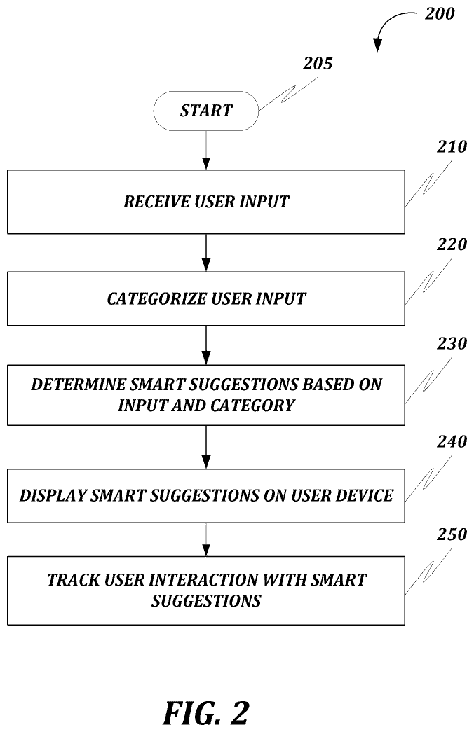

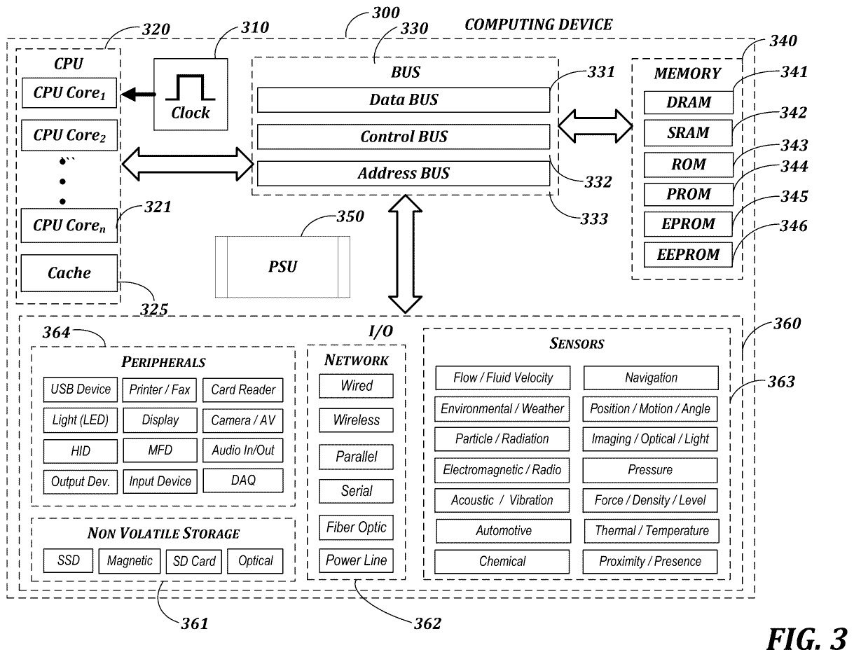

FIG. 2 is a flow chart setting forth the general stages involved in a method 200 consistent with an embodiment of the disclosure for suggesting intelligent actions based on user input. Method 200 may be implemented using a computing device 300 or any other component associated with platform 100 as described in more detail below with respect to FIG. 3. For illustrative purposes alone, computing device 300 is described as one potential actor in the following stages.

Method 200 may begin at stage 210 where computing device 300 may receive user input from a user device, such as a smartphone or computer, via an application interface that accepts text, spoken commands, or graphical selections.

In some embodiments, receiving user input from the user device may involve multiple modalities and system architectures. The user device may be a smartphone, tablet, laptop, desktop computer, wearable device, smart speaker, or any network-connected computing system.

The application may present a graphical user interface (GUI) through which the user may enter text using an on-screen virtual keyboard, a physical keyboard, keypad, touch-sensitive display, or other input device. Additionally or alternatively, the application may provide an option for the user to input data by voice, which may be captured by a built-in or external microphone and processed with speech recognition software, converting spoken instructions into text data for further analysis. In alternative embodiments, user input may be received in the form of handwritten characters, images, or audio recordings, which the application may digitize and preprocess for AI-based analysis. The user device may initiate secure, authenticated communication with the computing device via network protocols such as HTTPS or Bluetooth, transmitting the captured user input data as encrypted payloads. Furthermore, the system may support continuous input monitoring to receive background voice commands or proactively offer prompts for input based on context detected by the application. This flexibility in user input modalities allows the method to support a wide range of user preferences, accessibility requirements, and device capabilities.

In stage 220, the computing device 300 may categorize the user input. By executing artificial intelligence algorithms, the processor may analyze the user input to determine one or more relevant categories, for example, identifying an input as relating to scheduling, contacts, or events.

In some embodiments, categorizing the user input into at least one category using artificial intelligence processing may involve several analytical steps performed by the processor. Upon receiving the user input, the computing device may initially preprocess the data by normalizing text, removing extraneous symbols, and applying language detection algorithms to ensure accurate downstream analysis. The processor may execute one or more machine learning models, such as deep neural networks or decision tree classifiers, trained on large datasets of user input examples labeled by category. These models may leverage natural language processing (NLP) techniques, including tokenization, part-of-speech tagging, named entity recognition, and sentiment analysis, to extract features and context from the input data. In some cases, the system may utilize pre-trained language models, such as transformers, to provide semantic understanding and context-aware categorization. The output from these AI models may assign the user input to one or more predefined categories, such as “event,” “reminder,” “contact information,” “location-based inquiry,” or custom categories defined by system administrators or adaptively learned from user behavior. The categorization process may further incorporate contextual data such as user history, device type, current location, and time, enabling more precise and relevant grouping of user inputs. Confidence scores may be assigned to each category, and, in instances where uncertainty exists, the system may prompt the user to confirm or refine the proposed categorization.

In embodiments, the categories that user input may be classified into may include (but need not be limited to) products, books, authors, groceries, locations, restaurants, foods, music albums, artists, songs, movies, actors, TV shows, concerts, shows, sports, videos, electronics, birthdays, anniversaries, contacts, flights, hotels, rental cars, home services, professional services, freelance work, and jobs.

Based on the categorized input, the computing device 300 may generate at least one smart suggestion in stage 230. The smart suggestions, may include, as non-limiting examples, proposing to create a calendar event, pulling up relevant contacts, or offering location-based services.

In some embodiments, generating at least one smart suggestion based on the user input and the at least one category may be performed by a suggestion module operating within the computing device. The processor may analyze both the content and categorical context of the user input to determine potential actions or responses tailored to the user's intent. For example, if the user input is categorized as an “event,” the system may generate suggestions such as creating a new calendar entry, sending an invitation to relevant contacts, or setting a reminder for a specified date and time. The suggestion module may access local and/or cloud-based resources, such as user history, commonly performed actions, or applicable third-party integrations, to further personalize and contextualize suggestions. Artificial intelligence algorithms may rank suggestions based on predicted user preference, historical acceptance rates, and contextual relevance. For user inputs categorized as “contact information,” the system may suggest adding a new contact, initiating a call or message, or linking the information to an existing contact profile. The smart suggestions may be accompanied by relevant metadata, icons, or short descriptions to inform the user about the action or resource provided. Additionally, the module may support adaptive learning by updating its suggestion logic based on user feedback and ongoing interactions, thereby continuously refining the accuracy and utility of generated suggestions.

To generate the smart suggestion, the computing device 300 may send a prompt based on the category to an artificial intelligence model. The artificial intelligence model may then provide a response comprising one or more smart suggestions. The one or more smart suggestions may be formed as one or more links that, when actuated, cause a device (e.g., the user device) to perform a particular action, perform an action on the user's behalf, or prompt an additional action (e.g., pick up dog food). As specific examples, the action may include directing the user to an external website related to the input, creating a calendar appointment related to the input, causing playback or one or more media files related to the input, retrieving directions to a business associated with the input, and/or any other action related to the input that may be beneficial to the user, based on the input and the determined category.

In some embodiments, generating the smart suggestions may include processing at least one or more links. The processing may include, as an example, inserting an affiliate code into the link. The affiliate code may allow the computing device and/or the website associated with the link to track traffic driven outside the platform. This tracking may be useful for observing various metrics, including the success rate of the generated smart suggestions. Additionally or alternatively, the affiliate code may provide a way for the external platform to provide compensation to the owners of the platform 100 and/or any other party involved.

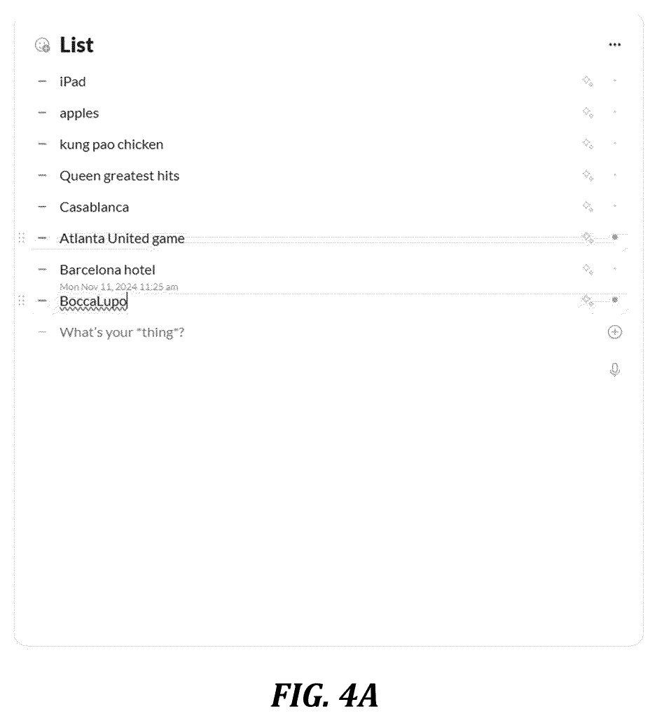

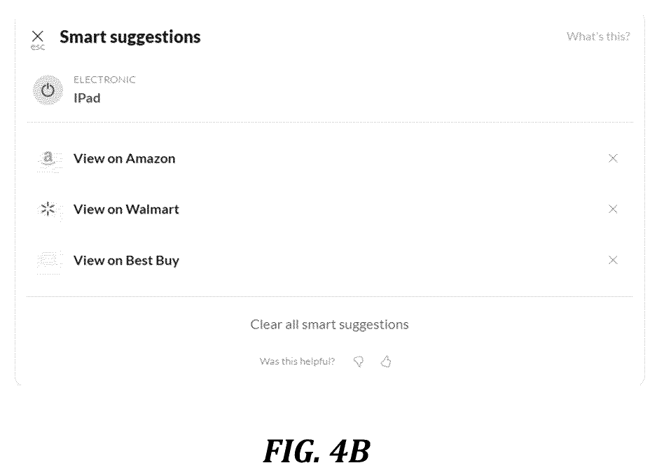

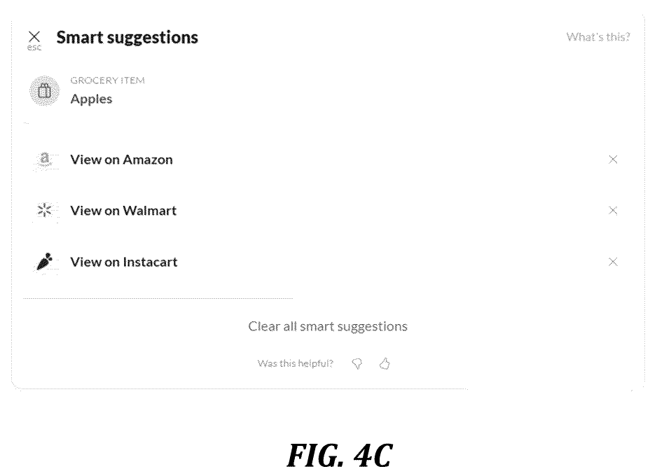

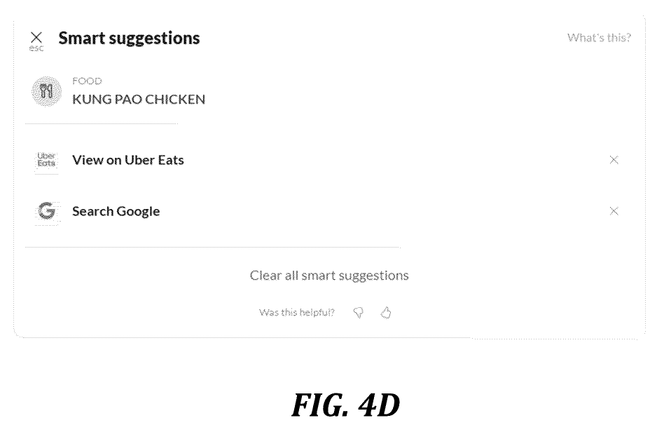

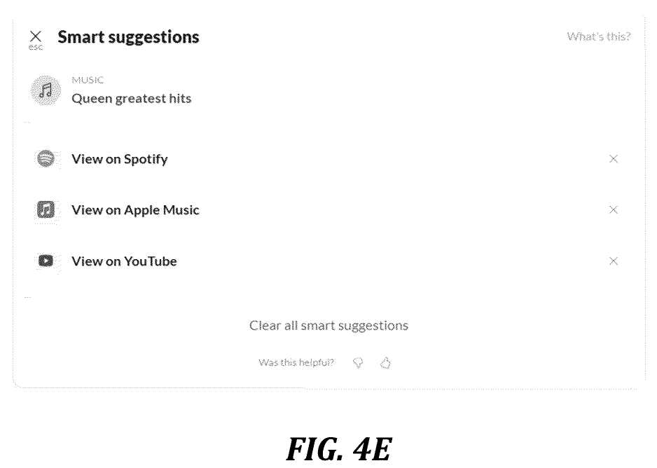

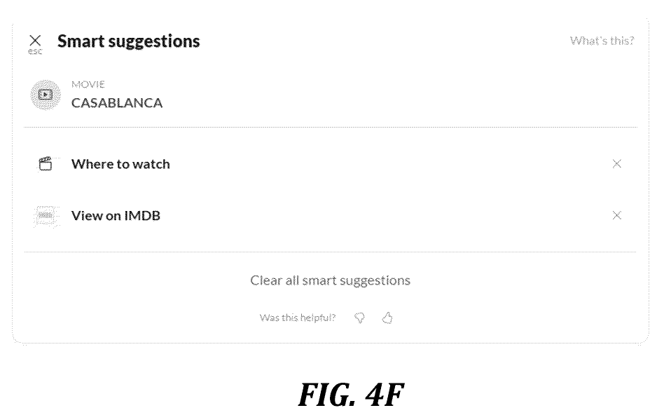

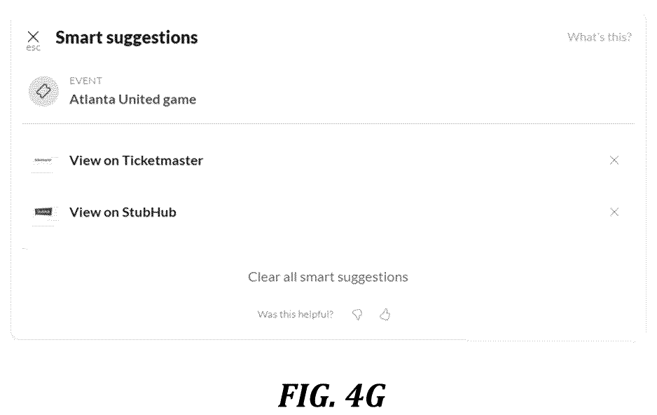

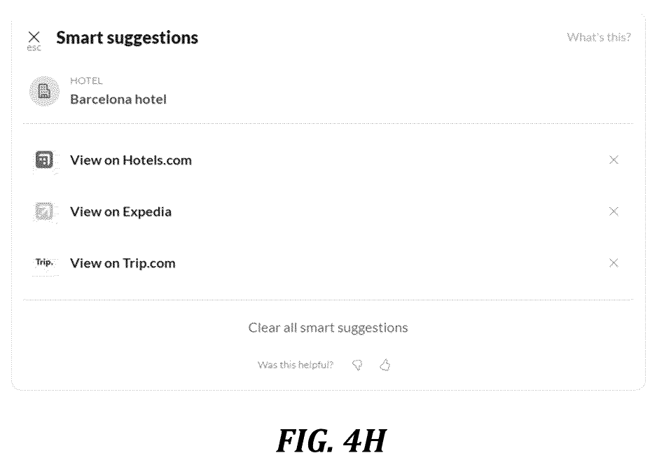

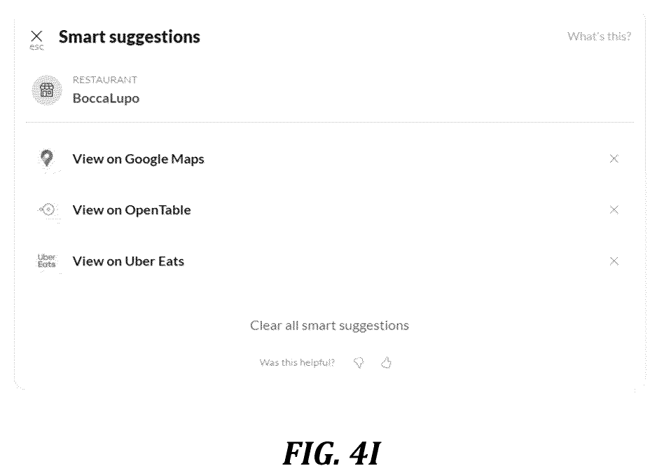

In stage 240, the suggestion may be transmitted to the user device for display through a graphical user interface, enabling the user to review and select a desired suggestion. Additionally, or alternatively, the generated smart suggestions may be stored in the database, associated with the user account (and/or the user input). Storing the smart suggestions to the database may allow the user to view the suggestions from any device associated with the user account. The smart suggestions may be displayed alongside or in association with the original user input in the application interface. For example, as shown in FIG. 4A, an icon (e.g., a diamond icon or other indicator icon) may be displayed next to the user input, indicating that one or more smart suggestions have been provided. Actuation or selection of the icon may allow the user to view and/or interact with the one or more smart suggestions.

In some embodiments, generating at least one smart suggestion based on the user input and the at least one category may be performed by a suggestion module operating within the computing device. The processor may analyze both the content and categorical context of the user input to determine potential actions or responses tailored to the user's intent. For example, if the user input is categorized as an “event,” the system may generate suggestions such as creating a new calendar entry, sending an invitation to relevant contacts, or setting a reminder for a specified date and time. The suggestion module may access both local and cloud-based resources, such as user history, commonly performed actions, or applicable third-party integrations, to further personalize and contextualize suggestions. Artificial intelligence algorithms may rank suggestions based on predicted user preference, historical acceptance rates, and contextual relevance. For user inputs categorized as “contact information,” the system may suggest adding a new contact, initiating a call or message, or linking the information to an existing contact profile. The smart suggestions may be accompanied by relevant metadata, icons, or short descriptions to inform the user about the action or resource provided. Additionally, the module may support adaptive learning by updating its suggestion logic based on user feedback and ongoing interactions, thereby continuously refining the accuracy and utility of generated suggestions.

In stage 250, the processor may determine that a user has actuated or otherwise selected a particular smart suggestion.

In some embodiments, receiving a user selection of the at least one smart suggestion may be facilitated through various types of user interface controls and input methods. The user device may present the smart suggestions as selectable options, such as buttons, interactive list items, or gesture-activated elements, within the application or notification interface. The user may make a selection by tapping, clicking, or pressing on the desired suggestion when using a touchscreen or mouse, or by issuing a spoken command recognized by the device's voice interface. In alternative embodiments, selection may occur through assistive technologies, such as screen readers, keyboard navigation, or eye-tracking systems to ensure accessibility for users with disabilities. The application may detect an explicit user action corresponding to the selection and then generate an event or data packet indicating the chosen suggestion. This event may be transmitted to the computing device for processing if computation occurs remotely, or handled locally if the device is self-contained. The system may also implement mechanisms to handle inadvertent selections, such as requiring confirmation before executing critical or irreversible actions. Log entries or analytic data may be recorded to monitor usage patterns and improve the relevance and performance of future suggestions.

Upon detecting a user selection, the processor may provide a link to an external resource corresponding to the selected suggestion in stage 260. For example, the processor may launch a calendaring service, connect to a directory, or initiate an associated application on the device. These operations may be performed locally on the user device or using a combination of local and cloud-based resources.

In some embodiments, providing a link to an external resource associated with the at least one smart suggestion in response to the user selection may involve several technical operations executed by the computing device. Upon detecting the user's selection, the processor may identify a relevant external resource by querying internal and/or external databases, mapping the selected suggestion to a corresponding URL, deep link, or application-specific resource identifier. The system may dynamically generate the link based on attributes of the user input, such as date, location, or contextual category, ensuring the provided resource is both current and customized to the user's situation. For example, if the user selects a suggestion to schedule an appointment, the processor may provide a link that opens a calendar service pre-populated with event details; if the suggestion involves locating a service provider, the link may lead to a map application displaying providers near the user's location. The link may be presented as a clickable item within the user interface or, in some embodiments, may automatically launch the relevant external application or website using platform-specific deep linking capabilities. The system may also verify the accessibility and security of the external resource before presenting the link, alerting the user to potential risks or authentication requirements as necessary. Additionally, records of the link provision may be stored for activity tracking, audit, or analytics purposes as permitted by privacy policies.

### IV. Hardware Architecture

Embodiments of the present disclosure provide a hardware and software platform operative as a distributed system of modules and computing elements.

In some embodiments, a computing device may include a processor and a memory storing instructions for executing the operations described herein. The user interface may be implemented as a touchscreen, keyboard, voice recognition module, or other input mechanism that allows a user to interact with the computing device. The processor may execute artificial intelligence algorithms to categorize user input and generate contextually relevant suggestions in real time. The communication interface may enable data exchange with external servers or resources over a network. Each of the modules described, including the categorization module, suggestion module, and processing module, may be implemented as machine-executable instructions in memory, configured to perform their respective functions when executed by the processor. By leveraging these technological components, the system can process user input and generate smart suggestions more efficiently and accurately than would be feasible through manual or mental methods.

In some embodiments, the memory may comprise one or more non-transitory, computer-readable storage media that store software instructions configured to be executed by the processor. The processor may be embodied as one or more general-purpose microprocessors, digital signal processors, application-specific integrated circuits, or combinations thereof. The processor may execute stored instructions from the memory to perform all system operations described herein, including receiving user input, categorizing the input, generating smart suggestions, transmitting suggestions, handling user selections, and providing links to external resources. The components cooperate within a single device or may be distributed in a network-connected computing environment.

The technical implementation supports improvements to computer functionality by automating the semantic analysis of unstructured content and facilitating seamless integration with internal device functions and external platforms using APIs and secure protocols. The system's modular architecture enables distributed computation, data encryption, and privacy-preserving machine learning across cloud and edge environments. These features reduce latency, minimize user intervention, and enable scalable operation, representing a practical application of artificial intelligence for productive computing device operation.

Platform 100 may be embodied as, for example, but not be limited to, a website, a web application, a desktop application, a backend application, and a mobile application compatible with a computing device 300. The computing device 300 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication on at least one network.

Embodiments of the present disclosure may comprise a system having a central processing unit (CPU) 320, a bus 330, a memory unit 340, a power supply unit (PSU) 350, and one or more Input / Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for redundancy, high availability, and/or performance purposes. The combination of the presently disclosed units is configured to perform the stages of any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, and the memory unit 340, consistent with embodiments of the disclosure.

At least one computing device 300 may be embodied as any of the computing elements illustrated in all of the attached figures, including [list the modules and methods]. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In some configurations, the computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

In a system consistent with an embodiment of the disclosure, the computing device 300 may include the clock module 310, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 320, the central component of modern computers, which relies on a clock signal. The clock 310 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 300 may use a “clock multiplier” which multiplies a lower frequency external clock to the appropriate clock rate of the CPU 320. This allows the CPU 320 to operate at a much higher frequency than the rest of the computing device 300, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

In a system consistent with an embodiment of the disclosure, the computing device 300 may include the CPU 320 comprising at least one CPU Core 321. In other embodiments, the CPU 320 may include a plurality of identical CPU cores 321, such as, but not limited to, homogeneous multi-core systems. It is also possible for the plurality of CPU cores 321 to comprise different CPU cores 321, such as, but not limited to, heterogeneous multi-core systems, big. LITTLE systems and some AMD accelerated processing units (APU). The CPU 320 reads and executes program instructions which may be used across many application domains, for example, but not limited to, general purpose computing, embedded computing, network computing, digital signal processing (DSP), and graphics processing (GPU). The CPU 320 may run multiple instructions on separate CPU cores 321 simultaneously. The CPU 320 may be integrated into at least one of a single integrated circuit die, and multiple dies in a single chip package. The single integrated circuit die and/or the multiple dies in a single chip package may contain a plurality of other elements of the computing device 300, for example, but not limited to, the clock 310, the bus 330, the memory 340, and I/O 360.

The CPU 320 may contain cache 322 such as but not limited to a level 1 cache, a level 2 cache, a level 3 cache, or combinations thereof. The cache 322 may or may not be shared amongst a plurality of CPU cores 321. The cache 322 sharing may comprise at least one of message passing and inter-core communication methods used for the at least one CPU Core 321 to communicate with the cache 322. The inter-core communication methods may comprise, but not be limited to, bus, ring, two-dimensional mesh, and crossbar. The aforementioned CPU 320 may employ symmetric multiprocessing (SMP) design.

The one or more CPU cores 321 may comprise soft microprocessor cores on a single field programmable gate array (FPGA), such as semiconductor intellectual property cores (IP Core). The architectures of the one or more CPU cores 321 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the computing device 300, and/or the plurality of computing devices 300. The aforementioned communication system will be known to a person having ordinary skill in the art as a bus 330. The bus 330 may embody internal and/or external hardware and software components, for example, but not limited to a wire, an optical fiber, various communication protocols, and/or any physical arrangement that provides the same logical function as a parallel electrical bus. The bus 330 may comprise at least one of a parallel bus, wherein the parallel bus carries data words in parallel on multiple wires; and a serial bus, wherein the serial bus carries data in bit-wise serial form. The bus 330 may embody a plurality of topologies, for example, but not limited to, a multidrop/electrical parallel topology, a daisy chain topology, and connected by switched hubs, such as a USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (midi)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 300 may employ hardware integrated circuits that store information for immediate use in the computing device 300, known to persons having ordinary skill in the art as primary storage or memory 340. The memory 340 operates at high speed, distinguishing it from the non-volatile storage sub-module 361, which may be referred to as secondary or tertiary storage, which provides relatively slower-access to information but offers higher storage capacity. The data contained in memory 340, may be transferred to secondary storage via techniques such as, but not limited to, virtual memory and swap. The memory 340 may be associated with addressable semiconductor memory, such as integrated circuits consisting of silicon-based transistors, that may be used as primary storage or for other purposes in the computing device 300. The memory 340 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 300 may employ a communication system between an information processing system, such as the computing device 300, and the outside world, for example, but not limited to, human, environment, and another computing device 300. The aforementioned communication system may be known to a person having ordinary skill in the art as an Input/Output (I/O) module 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces with a plurality of hardware, such as, but not limited to, non-volatile storage 361, communication devices 362, sensors 363, and peripherals 364. The plurality of hardware is used by at least one of, but not limited to, humans, the environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ a non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using an intermediate area in the memory 340. The non-volatile storage sub-module 361 may not lose data when power is removed and may be orders of magnitude less costly than storage used in memory 340. Further, the non-volatile storage sub-module 361 may have a slower speed and higher latency than in other areas of the computing device 300. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 300 may employ a communication sub-module 362 as a subset of the I/O module 360, which may be referred to by a person having ordinary skill in the art as at least one of, but not limited to, a computer network, a data network, and a network. The network may allow computing devices 300 to exchange data using connections, which may also be known to a person having ordinary skill in the art as data links, which may include data links between network nodes. The nodes may comprise networked computer devices 300 that may be configured to originate, route, and/or terminate data. The nodes may be identified by network addresses and may include a plurality of hosts consistent with the embodiments of a computing device 300. Examples of computing devices that may include a communication sub-module 362 include, but are not limited to, personal computers, phones, servers, drones, and networking devices such as, but not limited to, hubs, switches, routers, modems, and firewalls.

Two nodes can be considered networked together when one computing device 300 can exchange information with the other computing device 300, regardless of any direct connection between the two computing devices 300. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 362 may comprise a plurality of size, topology, traffic control mechanisms and organizational intent policies. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 300 may employ a sensors sub-module 363 as a subset of the I/O 360. The sensors sub-module 363 comprises at least one of the device, module, or subsystem whose purpose is to detect events or changes in its environment and send the information to the computing device 300. Sensors may be sensitive to the property they are configured to measure, may not be sensitive to any property not measured but be encountered in its application, and may not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte- insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ a peripherals sub-module 364 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 300 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 362), data storage devices (non-volatile storage 361), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Example Embodiments

The following discloses various example operations of the platform 100. The various example operations are not to be construed as limiting, but rather as providing context for the operations of the platform.

By way of example, a user types “Dinner with Alex at 6pm tomorrow” into the application interface. The system preprocesses and tokenizes the text, detects named entities (“Alex”, “6 pm”), and classifies the entry as both an event and a reminder. The suggestion module, drawing on external and internal APIs, presents three ranked suggestions: (1) create a calendar event with invite to Alex, (2) set a reminder for 5:45 pm tomorrow, and (3) pull up local restaurants for reservation. The user clicks “Create Event”, prompting the system to populate a new event in the user's linked calendar and send an invitation to Alex. These actions, along with time, platform, and user, are logged for analytics and synchronization with any device the user signs into later.

As shown in FIG. 4A, user inputs are aggregated into a list. The list may contain items in one or more different categories.

Where the input corresponds to an object (e.g., a physical product, a grocery item, etc.) the system may provide one or more links to allow the user to purchase the object or display information for the object such as cost or quantity available. As shown in the examples in FIGS. 4B-4D, the links may be to one or more online retailers (e.g., Amazon, Walmart, Target, etc.), and/or to one or more shopping services (e.g., Instacart, etc.). In some embodiments, where the object is a food item, the one or more links may include recipes that use that food item (in the case of a raw ingredient), recipes to make the food item, and/or restaurants that sell that food item, and the information may be the cost at a particular store or a discount available at a store.

As shown in FIGS. 4E and 4F, where the user input relates to a content item (album, song, movie, tv show, etc.) and/or an artist (musical artist, actor) the system may generate links for playback of a content item related to the input. For example, the platform may provide a link to one or more content streaming services from which the content can be played, links to one or more online retailers that sell physical copies of the content item, links to event ticket providers related to the content, and/or links to one or more reviews of the content item.

As shown in FIG. 4G, where the user input corresponds to an event (e.g., a sporting event, concert, etc.), the one or more links may include links to purchase tickets to the event, links to add the event to a calendar, and/or links to view a recording of the event.

Where the user inputs a desired service (e.g., hotel, rental car flight destination, etc.), the one or more links may include links to schedule the requested service and/or reviews for the requested service. For example, as shown in FIG. 4H, where the user inputs “Barcelona hotels” the platform may include links to one or more hotels in Barcelona, and/or links to hotel ratings or reviews in Barcelona.

Where the user input includes a restaurant name, as shown in FIG. 4I, the one or more links may include a link to make a reservation at the restaurant and/or to order from the restaurant, a link for directions to the restaurant, a link to book a car service (e.g., taxi, limo, rideshare, etc.) to drive to the restaurant, and/or one or more reviews of the restaurant.

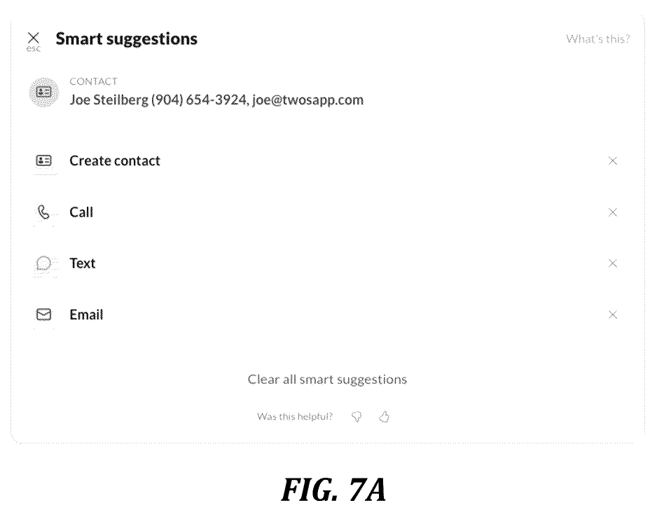

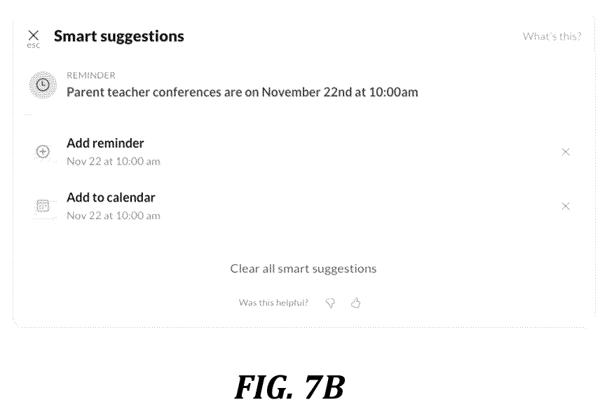

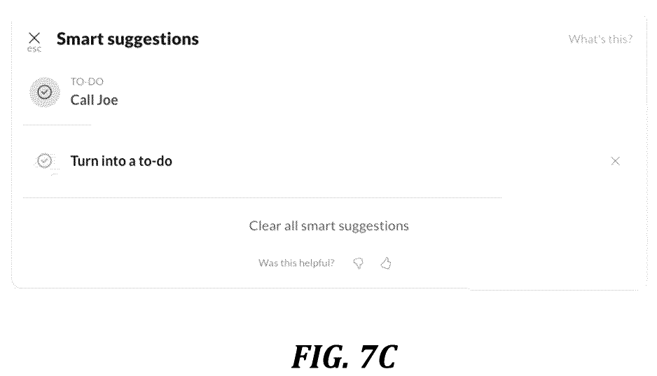

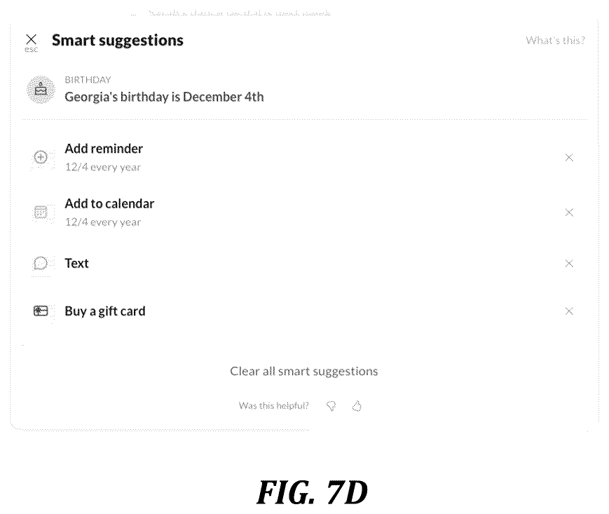

In some embodiments, the suggestion generated may cause generation of a link to an internal (e.g., on-device) service, as shown in FIGS. 7A-7D. Where the user input includes a contact in the user's address book, the system may output a link allowing the user to text or call the contact. As shown in FIG. 7A, a user entry containing a name and a piece of contact information (e.g., phone number, email address, etc.) may cause the system to generate a smart suggestion for contact creation. For example, the smart suggestion may create a link that, if actuated, will create a new contact on the user device. In some embodiments, the smart suggestion may also cause the user to contact the person using the contact information (e.g., send a text message, send email, call).

As shown in FIG. 7B, a user input that includes a time in the future may result a smart suggestion that includes a link to cause creation of a calendar entry and/or setting a reminder. For example, a user input of “Call mom next week” may create a smart suggestion to turn the entry into a to-do and set a reminder for next week. In some embodiments, including a data or range of dates in a user input may result in generation of a smart suggestion that creates a calendar event. For example, a user input of “Finish project from November 17^{th} to November 25^{th}” may result in creation of a smart suggestion to add “Finish project” to a connected calendar. As shown in FIG. 7C, a user entry to “call Joe” may cause generation of a smart suggestion to create a to-do list item. In some embodiments, the system may also create a reminder item.

The smart suggestions may create a recurring event. For example, as shown in FIG. 7D, a user input of “Georgia's birthday is December 4^{th}” may create a smart suggestion to create a smart suggestion to set a yearly repeating reminder and may generate and/or send a birthday text message. In some embodiments, the input may also add the birthday to contact information associated with Georgia.

In some embodiments, the platform's intelligent suggestion mechanisms may autonomously initiate or schedule the suggested actions upon user authorization. This automation layer, referred to in certain embodiments as Personal Active Lists (PALs), enables the system to not only recommend but also perform tasks such as message delivery, event creation, and purchase confirmation.

This process improves computing efficiency by reducing redundant processing and enabling real-time action generation.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized that the scope of this disclosure is much broader than presented by the claims. It is intended that broader claims will be submitted in an application that claims the benefit of priority from this application.

What is claimed is:

1. A computing device comprising:
at least one processor and memory storing instructions that, when executed by the at least one processor, cause the computing device to:
receive, via a user interface, user input from a device associated with a user;
process the received user input, by the processor using a categorization module comprising at least one artificial intelligence model stored in the memory to determine at least one category of information associated with the user input;
generate, by the processor and via a suggestion module stored in the memory, at least one smart suggestion based on the user input and the at least one category;
transmit, by the processor and via a communication interface, the at least one smart suggestion to the user interface for display;
receive, by the processor and via the communication interface, a user selection of the at least one smart suggestion; and
provide, by the processor and via a processing module implemented, a link to an external resource associated with the at least one smart suggestion in response to a user selection of the at least one smart suggestion.

2. The method of claim 1, wherein categorizing the user input comprises:
transmitting the user input to an artificial intelligence model;
analyzing semantic content of the user input using natural language processing; and
determining the at least one category based on the semantic content analysis.

3. The method of claim 1, wherein generating the at least one smart suggestion comprises:
creating a prompt based on the at least one category and the user input;
sending the prompt to an artificial intelligence model; and
receiving a response from the artificial intelligence model comprising the at least one smart suggestion.

4. The method of claim 1, wherein the link to the external resource comprises an affiliate link configured to track user interactions and generate revenue.

5. The method of claim 1, further comprising:
storing the user input and the at least one smart suggestion in a database; and
associating the stored data with a user account.

6. The method of claim 5, further comprising:
synchronizing the user input and the at least one smart suggestion across multiple user devices associated with the user account.

7. The method of claim 1, wherein the at least one category comprises at least one of: products, books, authors, groceries, locations, restaurants, foods, music albums, artists, songs, movies, actors, TV shows, concerts, shows, sports, videos, electronics, birthdays, anniversaries, contacts, flights, hotels, rental cars, home services, professional services, freelance work, and jobs.

8. The method of claim 1, wherein the external resource comprises at least one of: an e-commerce platform, a social media platform, an entertainment platform, a travel booking system, a job search platform, and a professional services platform.

9. The method of claim 1, further comprising:
tracking user interactions with the link to the external resource;
generating analytics data based on the tracked user interactions; and
refining suggestion algorithms based on the analytics data.

10. The method of claim 1, further comprising:
receiving a plurality of user inputs;
analyzing the plurality of user inputs collectively; and
generating an aggregated smart suggestion that encompasses multiple items from the plurality of user inputs.

11. The method of claim 1, wherein the at least one smart suggestion comprises at least one of: a link to purchase an item, a link to create a calendar event, a link to set a reminder, a link to create a contact, a link to send a message, and a link to access content.

12. A system comprising:
at least one processor;
a memory storing instructions that, when executed by the at least one processor, cause the system to:
receive, by the at least one processor, user input from a user device via a user interface;
apply, by the at least one processor, a machine-learned artificial intelligence model stored in the memory to categorize the user input into at least one category;
generate, by the at least one processor, at least one smart suggestion based on the user input and the at least one category;
transmit, by the at least one processor, the at least one smart suggestion to the user device for display;
receive, by the at least one processor, a user selection of the at least one smart suggestion; and
provide, by the processor, a link to an external resource associated with the at least one smart suggestion in response to the user selection.

13. The system of claim 12, wherein the processor is further configured to:
analyze contextual information associated with the user input, wherein the contextual information comprises at least one of: user location, timestamp, and input method; and
generate the at least one smart suggestion based on the contextual information.

14. The system of claim 12, wherein the processor is further configured to:
process the user input using a machine learning model trained on labeled datasets of categorized inputs; and
assign confidence scores to each determined category.

15. The system of claim 12, wherein the processor is further configured to:
integrate with external platforms via application programming interfaces;
retrieve real-time information from the external platforms; and
incorporate the real-time information into the at least one smart suggestion.

16. The system of claim 12, wherein the processor is further configured to:
analyze historical user interaction data;
personalize the at least one smart suggestion based on user preferences derived from the historical data; and
prioritize suggestions based on user engagement potential.

17. A computing device comprising:
at least one processor;
at least one memory storing instructions that, when executed by the at least one processor, cause the computing device to:
receive, via a user interface, user input from a user device;
analyze, by the at least one processor and using a categorization module, the user input to determine at least one category using artificial intelligence processing;
generate, by the at least one processor and using a suggestion module, at least one smart suggestion based on the user input and the at least one category;
format, by the at least one processor and using a suggestion processing module, the at least one smart suggestion for display and integrate one or more affiliate codes into a link associated with the smart suggestion; and
facilitate, by the at least one processor and using a communication interface, interaction with one or more external resources by transmitting the link to the user device for display.

18. The computing device of claim 17, further comprising:
an artificial intelligence module comprising a machine learning engine configured to train and execute machine learning models for categorizing user input and generating suggestions.

19. The computing device of claim 17, wherein the suggestion module is configured to:
interface with multiple external platforms simultaneously;
generate suggestions that aggregate multiple user inputs into single actionable recommendations; and
adapt suggestion generation based on user feedback.

20. The computing device of claim 17, wherein the user interface is configured to:
display the at least one smart suggestion as interactive elements comprising buttons and hyperlinks;
receive user selections of the interactive elements; and
facilitate navigation to external resources associated with selected suggestions.
